(19) United States
(12) Patent Application Publication
(10) Pub. No.: US 2026/0310275 A1
(43) Pub. Date: Oct. 8, 2026

(54) DYNAMIC MULTIPHASE VOLTAGE REGULATOR FOR RAPID VOLTAGE SWITCHING

(71) Applicant: Groq, Inc., San Jose, CA (US)

(72) Inventor: Santosh Raghavan, Mountain View, CA (US)

(21) Appl. No.: 19/638,738

(22) Filed: Apr. 3, 2026

Related U.S. Application Data
(60) Provisional application No. 63/783,705, filed on Apr. 4, 2025.

(51) Int. Cl. G06F 1/30

(52) U.S. Cl. CPC G06F 1/305

(57) ABSTRACT

In an aspect, the present disclosure provides an example computing system. In some implementations, the example computing system includes a deterministic processor. In some implementations, the example computing system includes a compiler configured to translate a program into a deterministic schedule including a plurality of operations defined for implementation on the deterministic processor. In some implementations, the example computing system includes a voltage regulator network (VRN) including a plurality of phases. In some implementations, the example computing system includes a power management integrated circuit (PMIC) controller configured to obtain the deterministic schedule from the compiler. In some implementations, the example computing system includes a power management integrated circuit (PMIC) controller configured to determine a voltage signal to be used in generating a clock signal for the deterministic processor. In some implementations, the example computing system includes a power management integrated circuit (PMIC) controller configured to determine a control signal to be applied to the VRN based on the voltage signal. In some implementations, the example computing system includes a power management integrated circuit (PMIC) controller configured to control the VRN using the control signal to deliver the voltage signal to the deterministic processor.

### CROSS REFERENCE TO PRIORITY APPLICATIONS

The present disclosure claims the benefit of priority to U.S. Provisional Application Ser. No. 63/783,705, entitled, “DYNAMIC MULTIPHASE VOLTAGE REGULATOR FOR RAPID VOLTAGE SWITCHING,” filed Apr. 4, 2025, the entirety of which is incorporated by reference herein.

### FIELD

The present disclosure relates generally to processors, such as processors for processing tensors. More particularly, the present disclosure relates to dynamic multiphase voltage regulators for rapid voltage switching.

### BACKGROUND

A tensor is a family of mathematical structures that includes vectors, matrices and higher dimensional arrays. Tensors are used in many fields of science and engineering, and huge tensors with millions to billions of elements are used in numerical calculations such as machine learning. Tensor operations such as multiplication require huge amounts of processing power for large tensors.

### SUMMARY

Aspects and advantages of implementations of the present disclosure will be set forth in part in the following description, or can be learned from the description, or can be learned through practice of the implementations.

In an aspect, the present disclosure provides an example computing system. In some implementations, the example computing system includes a deterministic processor. In some implementations, the example computing system includes a compiler configured to translate a program into a deterministic schedule including a plurality of operations defined for implementation on the deterministic processor. In some implementations, the example computing system includes a voltage regulator network (VRN) including a plurality of phases. In some implementations, the example computing system includes a power management integrated circuit (PMIC) controller configured to obtain the deterministic schedule from the compiler. In some implementations, the example computing system includes a power management integrated circuit (PMIC) controller configured to determine a voltage signal to be used in generating a clock signal for the deterministic processor. In some implementations, the example computing system includes a power management integrated circuit (PMIC) controller configured to determine a control signal to be applied to the VRN based on the voltage signal. In some implementations, the example computing system includes a power management integrated circuit (PMIC) controller configured to control the VRN using the control signal to deliver the voltage signal to the deterministic processor.

In an aspect, the present disclosure provides an example computer-implemented method. In some implementations, the example computer-implemented method includes obtaining a deterministic schedule defining operations of a deterministic processor from a compiler. In some implementations, the example computer-implemented method includes determining a voltage signal to be used in generating a clock signal for the deterministic processor. In some implementations, the example computer-implemented method includes determining a control signal to be applied to a voltage regulator network (VRN) based on the voltage signal. In some implementations, the example computer-implemented method includes controlling the VRN using the control signal to deliver the voltage signal to the deterministic processor.

In an aspect, the present disclosure provides an example power management integrated circuit (PMIC). A power management integrated circuit (PMIC) controller configured to obtain a deterministic schedule defining operations of a deterministic processor from a compiler. A power management integrated circuit (PMIC) controller configured to determine a voltage signal to be used in generating a clock signal for the deterministic processor. A power management integrated circuit (PMIC) controller configured to determine a control signal to be applied to a VRN based on the voltage signal. A power management integrated circuit (PMIC) controller configured to control the VRN using the control signal to deliver the voltage signal to the deterministic processor.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended Figures, in which:

FIG. 1 illustrates a diagram of a system according to example aspects of the present disclosure.

FIG. 2 illustrates a diagram of a system according to example aspects of the present disclosure.

FIG. 3 illustrates a diagram of a system according to example aspects of the present disclosure.

FIG. 4 illustrates a diagram of a system according to example aspects of the present disclosure.

FIG. 5 illustrates a diagram of a system according to example aspects of the present disclosure.

FIG. 6 illustrates a diagram of a system according to example aspects of the present disclosure.

FIGS. 7A-7B depict exemplary clock waveforms and power usage by the processor driven by the waveforms according to example aspects of the present disclosure.

FIG. 8 illustrates a diagram of a system according to example aspects of the present disclosure.

FIG. 9 illustrates a diagram of a system according to example aspects of the present disclosure.

FIG. 10 illustrates a flowchart diagram of a method according to example aspects of the present disclosure.

Repeat use of reference characters in the present specification and drawings is intended to represent the same and/or analogous features or elements of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

Very-high speed processors are at the heart of the latest generation of artificial intelligence (AI) systems. Often, hundreds to thousands of such processors, such as the Language Processing Unit or LPU (alternatively referred to as a tensor streaming processor (TSP)) can be used in a cluster to coordinate computations between processors. Due at least in part to the significant computational complexity of operations performed by these processors, significant efficiency gains can be attributable to dynamic power management of these processors. For instance, AI processing operations can frequently induce drastic changes in power demanded by portions of the processors as the processor shifts from a condition of relatively reduced load to relatively high load in a near-instantaneous manner. Some power management techniques can suffer from voltage drop as a result of this sudden, drastic shift in load power.

As one example, certain processing circuitry can provide for cycle-by-cycle period scaling (CPS). Cycle-by-cycle period scaling refers to a dynamic, cycle-dependent generation of unique clock signal periods for dynamically modifying operation speed of the processor with a significant degree of granularity. For instance, the operating frequency of a computer processor's system clock can impact certain generally desirable performance metrics of the computer processor, such as, for example, latency, throughput, peak power, energy usage, power supply load current demand/rate of change, and so on. Some existing approaches of manipulating clock frequency (e.g., by setting the clock frequency to a particular value during execution of an entire algorithm) can fail to provide adequate granularity for efficiency gains. As one particular example, in some cases, cycle-by-cycle period scaling may be applied by slowing the clock at initial load conditions to mitigate the voltage drop caused by significant increases in load. In one example implementation of cycle-by-cycle period scaling, for instance, clock period can be related to a frequency applied to a clock generation circuit of the processor. As one example, generation of a first clock frequency (e.g., 1 GHz) can involve application of a first voltage, and generation of a second clock frequency (e.g., 1.6 GHz) can involve application of a second (e.g., higher) voltage. This capability can be referred to as Dynamic Voltage and Frequency Scaling (DVFS). Adequately synchronizing the generated clock periods with operations of a language processing unit can involve fine-grained control of voltages with granularity on the order of nanoseconds or less than one nanosecond. Furthermore, operating continually at the highest possible voltage can cause power consumption inefficiencies.

Example aspects of the present disclosure can provide for dynamic multiphase voltage regulators for rapid voltage switching. The dynamic multiphase voltage regulators can be included in a variety of systems, such as processors, such as language processing units or other artificial intelligence processing circuitry. More particularly, example aspects of the present disclosure can be applied to deterministic processors. A deterministic processor can include a compiler that generates an explicit plan for how the processor will execute a program. For instance, the compiler can translate a program into a set of operations that are executed by the processor, specifying when each instruction will be executed, which portions (e.g., functional slices) of the processor will perform the work, and/or which stream registers will hold the operands. This type of scheduling is known as “deterministic scheduling.” This can be contrasted with other (e.g., non-deterministic) processors, where details of instruction execution are not planned for a significant portion of the program in advance.

According to example aspects of the present disclosure, in addition to scheduling information about instruction execution, the deterministic processor (e.g., a controller of the deterministic processor) can schedule desired clock period values to be generated by the processor clock at each cycle. While it can, in some implementations, be advantageous to schedule the clock period values for each cycle for an entire algorithm or program, some implementations of the present disclosure can schedule clock period values for only some portion of the algorithm. Based on the scheduled clock period values, the deterministic processor can determine a voltage signal for generating the scheduled clock period value respective to each scheduled clock period value (e.g., and/or respective to each processor cycle). Based on the voltage signal, the deterministic processor can further determine a predicted power demand at each processor cycle.

Some existing approaches for voltage scaling in integrated circuits can utilize multiphase voltage regulators that generally include an analog feedback loop facilitated by an inductive or capacitive component (e.g., a capacitor or inductor). These approaches can lack the rapid response time generally desirable for language processing units. This can largely be attributed to the slow response of the inductive or capacitive components. For example, when a capacitor is used for DVFS, voltage signals may not desirably stabilize until the capacitor is nearly or entirely charged, which can take significant time especially for larger capacitors. Thus, these approaches can lack the granularity and/or response speed providing for optimal power management, especially in deterministic computing architectures. Furthermore, other approaches, such as those that predict voltage drops and preemptively simulate a voltage drop at a VRN, can involve a few processor clock cycles to transfer voltage drop instructions, which can undesirably increase response time and can be unable to handle very fine-grained clock cycle changes, such as those that are shorter than the average time to transfer the voltage drop instructions.

Examples of the present disclosure provide a multiphase voltage regulator that provides improved responsiveness in applications that are time sensitive in voltage shifting. The voltage regulator can provide a plurality of voltage phases. Each phase can include a respective power stage and/or phase control circuitry. The power stage and phase control circuitry can provide for each phase to be independently operable. A subset of the total number of phases can output different pre-stabilized voltages. A switch can be coupled to the plurality of voltage phases such that the phases can be selectively toggled. By providing different pre-stabilized voltages at a subset of the voltage phases, a controller (e.g., a power management integrated circuit controller or PMIC controller) can selectively control which phases are applied for a particular compute cycle. The phases of the VRN can be coupled to a common power delivery network on the deterministic processor. By providing each phase at a common power delivery network, the VRN can provide even power distribution and/or mitigate effects of isolation between voltage domains. The PMIC controller can act as a central control unit for processors utilizing the VRN. For instance, the PMIC controller can orchestrate activation and/or deactivation of certain phases, such as phases that provide the same voltage, to provide rapid voltage transitions. The PMIC controller can communicate with the VRN to activate or deactivate the phases as needed. The PMIC controller can, in some implementations, provide for determining the clock periods and/or voltage signals to be generated at each compute cycle. For instance, the PMIC can implement various algorithms discussed further herein for determining voltage levels and clock periods based on targets such as performance targets and power consumption targets. The PMIC can provide smooth transitions to maintain system stability and/or prevent electrical glitches. Furthermore, the VRN according to the present disclosure can, in some implementations, include (e.g., only) linear components such as resistors, diodes, or transistors. The VRN can further provide for removing inductors, capacitors, and other components that behave nonlinearly with respect to time-varying voltage signals, or circuitry including such components (e.g., filters), from voltage provisioning. The voltage switching mechanisms of the VRN can thus provide for rapidly changing active phases, reducing transition time, and avoiding power disruptions.

For example, the processor can employ cycle-by-cycle period scaling, which can involve determining a voltage to be applied at a processor clock for each compute cycle. For example, the voltage that is applied to the processor clock can be generated using the VRN according to example aspects of the present disclosure.

Examples of the present disclosure can provide a number of technical effects and benefits including improvements to computing technology. As one example, the system described herein can provide for rapid adaption to changing workloads and optimize power usage for a processor. For instance, in deterministic architectures, the present disclosure can provide for determining a clock frequency, determining a voltage level, and applying the voltage level using the VRN. Therefore, the present disclosure can provide for matching voltage and frequency to workload demands on a cycle-by-cycle basis. The VRN of the present disclosure can support aggressive voltage and frequency scaling to improve processing power and/or reduce heat generation, thereby providing an improvement to computing hardware such as LPUs. Furthermore, the VRN of the present disclosure can significantly reduce slow response times typically associated with traditional multiphase voltage regulators.

Referring now to the FIGS., example aspects of the present disclosure will be discussed in greater detail. It should be understood that aspects discussed in reference to one Figure are expressly contemplated as being combinable with aspects of other FIGS. unless expressly indicated otherwise.

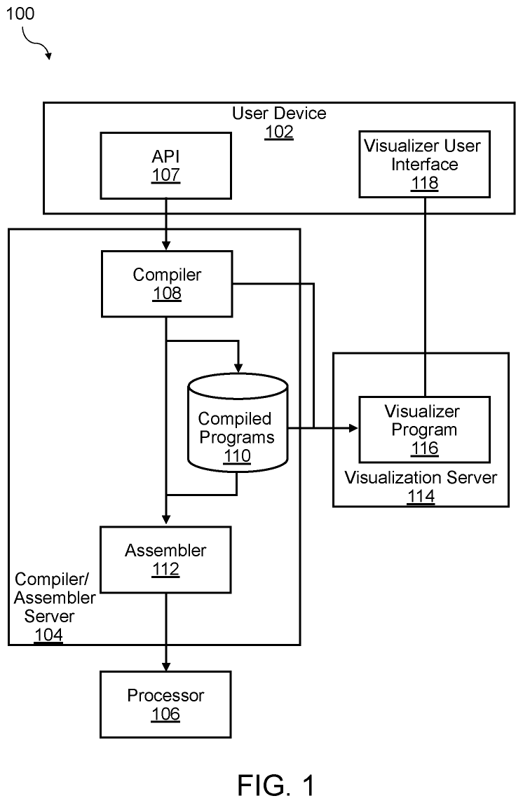

FIG. 1 illustrates a system 100 for compiling models to be executed on a tensor processor, according to an embodiment. The system 100 includes a user device 102, a server 104, and a processor 106. Each of these components are described in greater detail below. Although a particular configuration of components is described herein, in other embodiments the system 100 may have different components and these components perform the functions of the system 100 in a different order or using one or more different mechanisms. For example, while FIG. 1 illustrates a single server 104, in other embodiments, compilation, assembly, and/or power usage functions are performed on one or more different devices. For example, in some embodiments, at least a portion of the functions performed by the server 104 are performed by the user device 102 and/or multiple servers.

The user device 102 can be or can include any electronic computing device, such as a personal computer, laptop, or workstation. The user device 102 uses an Application Program Interface (API) 107 to construct programs to be run (e.g., executed) on the processor 106. The server 104 receives a program specified by the user (or other entity) at the user device 102 and compiles (e.g., via a compiler 108) the program to generate a compiled program 110 (or more than one compiled program). In some implementations, the program is specified automatically, or dynamically, without manual input from one or more users.

In some implementations, a compiled program 110 provides a data model for predictions that processes input data and makes a prediction from the input data. Examples of predictions include, but are not limited to, category classifications made with a classifier, or predictions of time series values. In some implementations, the prediction model describes a machine learning model that includes nodes, tensors, and/or weights.

In one implementation, the model is specified as a TensorFlow model, the compiler 108 is a TensorFlow compiler and the processor 106 is a tensor processor (e.g., an LPU). In another implementation, the prediction model is specified as a PyTorch model and the compiler is a PyTorch compiler. In other implementations, other machine learning specification languages and compilers are used. For example, in some implementations, the prediction model defines nodes representing operators (e.g., arithmetic operators, matrix transformation operators, Boolean operators, and so forth), tensors representing operands (e.g., values that the operators modify, such as scalar values, vector values, and matrix values, which may be represented in integer or floating-point format), and weight values that are generated and stored in the model after training. In some implementations, where the processor 106 is a tensor processor having a functional slice architecture, the compiler 108 generates an explicit plan for how the processor 106 will execute the program. Generating an explicit plan for how the processor 106 will execute a program can involve translating the program into a set of operations that are executed by the processor 106, such as specifying when each instruction will be executed, which functional slices will perform the work, and/or which stream registers will hold the operands. This type of scheduling is referred to as “deterministic scheduling.” Because the exact sequence of operations that will be executed by a processor (and, for example, by which functional units of the processor) can be known ahead of time due to the deterministic scheduling, such that there is little to no variance in execution of the program from the prespecified deterministic schedule, the explicit plan for execution can include or can be used to readily generate information for explicit prediction of excessive power usage by the processor when executing the program.

An assembler 112 receives compiled programs (e.g., the compiled program 110) generated by the compiler 108 and performs final compilation and channeling of the scheduled instructions to generate a compiled binary. In some implementations, the assembler 112 maps the scheduled instructions indicated in the compiled program 110 to the hardware of the server 104, and then determines the exact (or most appropriate) component queue in which to place each instruction.

The processor 106, for example, can be or can include a hardware device with a massive number of matrix multiplier units that accepts a compiled binary assembled by the assembler 112 and executes the instructions included in the compiled binary. The processor 106 can include one or more blocks of circuitry for matrix arithmetic, numerical conversion, vector computation, short-term memory, data permutation and/or data switching. One such processor 106 is a tensor processor having a functional slice architecture, such as an LPU. In some implementations, the processor 106 can be or can include multiple tensor processors connected together (e.g., by chip-to-chip communication units). In some implementations, if the compiler receives a large model having more weights than the available memory on one processor 106, the compiler can be configured to determine how to allocate the model across the available processor units.

The system 100 can, in some implementations, further include a visualization server 114 that includes a visualizer program 116 for visualizing the deterministic operation of processor 106. The output of the visualizer program 116 can be displayed on a user interface, such as a Visualizer User Interface 118, for example. The visualization server 114 can be useful for debugging purposes.

In accordance with some example aspects of the present disclosure, the processor 106 can be or can include a language processing unit. It is to be understood that although many implementations described herein use a language processing unit, other deterministic processors may be used in commercial applications (or other types of applications) and the disclosed implementations are not limited to a LPU implementation.

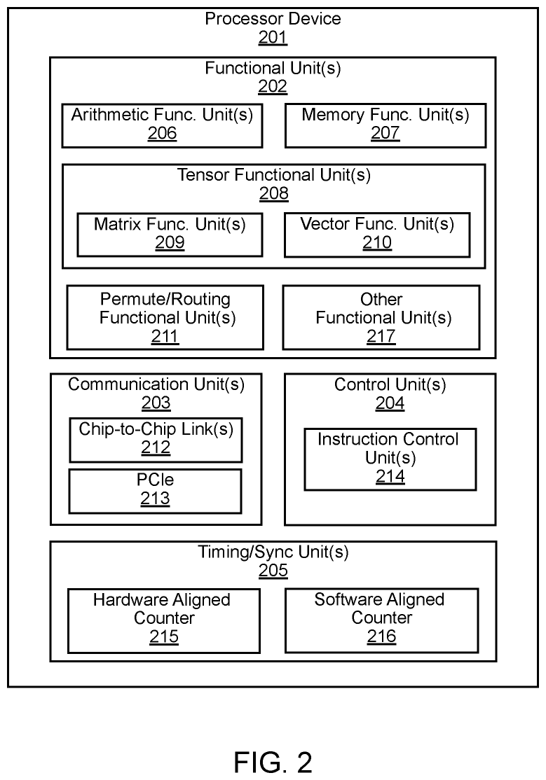

FIG. 2 is a block diagram of an example processor device 201 according to example implementations of aspects of the present disclosure. The processor device 201 can include one or more functional units 202; one or more communication units 203; one or more control units 204 (e.g., instruction control unit(s) 214, etc.); one or more timing or synchronization units 205; or other components. In some instances, functional unit(s) 202 of the processor device 201 can include one or more of: arithmetic functional unit(s) 206; memory functional unit(s) 207; tensor functional unit(s) 208 (e.g., matrix functional unit(s) 209, vector functional unit(s) 210, etc.), permute or routing functional units 211, or other functional units 217. Communication unit(s) 203 can include, for example, one or more of chip-to-chip communication link(s) 212, peripheral component interconnect express 213 components, or other communication unit(s) 203. Timing and synchronization units 205 can include, for example, one or more hardware-aligned counters 215, one or more software-aligned counters 216, or other timing or synchronization component.

A processor device 201 can include various types of processor architectures. In some instances, a processor device 201 can include a single-core or multi-core processor device 201. In some instances, a processor device 201 can include an integrated circuit located on a single die or a processor device 201 distributed over multiple dies connected together (e.g., directly connected such as via face-to-face connection, indirectly connected such as via one or more interposers, etc.). In some instances, a processor device 201 can include one or more of: one or more field-programmable gate arrays (FPGAs); one or more application-specific integrated circuits (ASICs), such as ASICs for machine-learned inference, matrix multiplication, floating-point operations, or the like; one or more graphics processor units (GPUs); one or more tensor processing devices; or other processor type. In some instances, a processor device 201 can include a deterministic processor device or a non-deterministic processor device (e.g., processor device configured to operate according to a deterministic or non-deterministic timing, etc.). In some instances, a processor device 201 can include a processor device having a plurality of dedicated special-purpose functional units, or a processor device having one or more general-purpose functional units (e.g., multi-core processor having a plurality of general-purpose processor cores, etc.). For example, in some instances, a processor device 201 can include a single-core processor device 201 having a plurality of special-purpose functional units 202 having distinct functions, such as functional units 202 having distinct instruction set architectures.

In some instances, a processor device 201 can include a deterministic processor device. A deterministic processor device can include, for example, a processor device configured to perform a plurality of operations according to a predetermined order, such as a predetermined program order defined by a compiler. In some instances, a deterministic processor device can include a processor device configured to perform a plurality of operations according to a predetermined timing or according to a predetermined temporal relationship between operations. For example, in some instances, a deterministic processor can include a processor configured to receive one or more computer-executable instructions (e.g., compiled instructions, etc.) including timing data; and execute the instruction(s) according to a predetermined time or predetermined temporal relationship indicated by the timing data. Timing data can include, for example, one or more of: data indicative of a clock cycle on which to execute a particular operation; data indicative of a temporal relationship between one or more first operations and one or more second operations, such as data indicative of a number of clock cycles to pause after a first operation (e.g., data transfer operation, instruction transfer operation, floating-point operation, etc.) is completed before performing a second operation (e.g., floating-point operation, tensor processing operation, etc.); data indicative of one or more operations or instructions configured to have an effect on a timing of operations, such as data indicative of one or more no-operation (NOP) operations or sleep operations, such as a repeated-NOP instruction to cause a functional unit 202 or other component of a processor device 201 to remain idle for a predetermined number of clock cycles; or other timing data.

In some instances, a deterministic processor device can include a processor device configured to receive, from a compiler, a set of computer-executable instructions controlling a timing of a plurality of operations associated with the computer-executable instructions; and perform the plurality of operations according to the timing. For example, in some instances, a deterministic processor device can include a processor device configured to receive a compiled program configured to cause, for each respective operation of a plurality of operations (e.g., arithmetic operations such as floating-point operations, tensor operations, etc.) to be performed on one or more respective data operands (e.g., numerical operands such as machine-learned model parameters, activation values, etc.), an instruction associated with the respective operation to intersect with the respective data operand at a predetermined time instant (e.g., clock cycle, clock cycle offset relative to an initial clock cycle, etc.) defined in the compiled program. In some instances, a deterministic processor can include a processor device having one or more components (e.g., functional unit(s) 202, communication unit(s) 203, etc.) having an instruction set architecture including instructions to control a timing of one or more operations of the one or more components.

In some instances, a deterministic processor device 201 can include a processor device configured to route data between functional units 202 of the processor device 201 according to a predetermined timing, predetermined routing or pathing, or both. For example, in some instances, a deterministic processor device 201 can include a processor device configured to receive compiled instructions including data indicative of one or more data transfers operations to be performed according to one or more predetermined routes determined by a compiler, according to one or more predetermined timing values defined by the compiler, or both. In this manner, for instance, a deterministic processor device 201 can provide for a compiler to perform compile-time load balancing for a plurality of data paths, and can execute a plurality of runtime data transfers according to the compile-time load balancing. Further details of an example compiler configured to perform compile-time load balancing are provided herein.

In some instances, a deterministic processor device 201 can include a processor that lacks one or more non-deterministic components that may be commonplace among non-deterministic processor devices, such as branch prediction units, tiered or hierarchical cache devices, runtime load balancing, or other sources of runtime non-determinism (e.g., non-deterministic timing of operations, non-deterministic choice of operations such as non-deterministic routing of data, etc.). For example, in some instances, a processor device 201 can lack any branch prediction components, and can be configured to execute every operation of a compiled program according to a predetermined program order. As another example, in some instances, one or more memory functional units 207 can lack a cache hierarchy or lack any non-deterministic memory component(s). For example, in some instances, one or more memory functional units 207 can be configured to operate deterministically, such as according to a predetermined timing defined by a compiler. For example, in some instances, one or more memory functional units 207 can be configured to perform one or more read operations at one or more times predetermined by a compiler; perform one or more write operations at one or more times predetermined by the compiler; perform one or more refresh operations at one or more times predetermined by the compiler, such that the compiler can have explicit control over a refresh timing of the memory functional unit(s) 207; or the like. For example, in some instances, the compiler can compile a program or other executable into a set of deterministic operations that can be executed by the functional unit(s) 202 at known times specified by a deterministic schedule.

However, although a deterministic processor device 201 can lack some common sources of non-determinism, in some instances, a deterministic processor device 201 can include or interact with one or more non-deterministic components or devices without deviating from the scope of the present disclosure. As a non-limiting illustrative example, in some instances, a deterministic processor device 201 can include a PCIe 213 component configured to perform external input/output (I/O) operations, which can in some instances include input/output operations having a non-deterministic timing (e.g., I/O operations using a non-deterministic PCIe 213 device; I/O operations receiving input from non-deterministic external device(s); etc.). In some instances, a deterministic processor device 201 can interact with non-deterministic component(s) or device(s) (e.g. components or devices internal or external to the processor, etc.), while maintaining deterministic operation of the remaining components of the processor device 201 by designating one or more predetermined time windows to interact with the non-deterministic component(s) in a deterministic manner. For example, in some instances, a processor device 201 can be configured to check, at each of a plurality of predetermined times, whether one or more inputs (e.g., inference request(s), etc.) has been received via a PCIe device 213; and, if the processor device 201 determines that an input has been received, to process the input (e.g., write the input to a designated memory location or region, etc.) according to a predetermined timing or predetermined set of instructions (e.g., according to a set of operations configured to fit within a predetermined time window reserved for non-deterministic external I/O operations, etc.).

In some instances, a processor device 201 can include a processor device configured for single-instruction multiple-data (SIMD) operation. For example, in some instances, a processor device 201 can be configured to receive one or more computer-executable instructions that are each indicative of an operation to be performed on a plurality of operands, such as a vector of numerical operands; a tensor of numerical operands; or the like. In some instances, a SIMD processor device can include a processor device configured to provide a single instruction to a plurality of functional units 202 (e.g., adjacent functional units 202 arranged in a functional region, etc.) to cause each respective functional unit 202 of the plurality of functional units 202 to execute the instruction on one or more distinct operands provided to the respective functional unit 202 (e.g., routed to the respective functional unit 202 according to a predetermined compiler-defined routing, etc.).

In some instances, a processor device 201 can include a single-core processor device, or a processor device configured to operate as a single-core device (e.g., flexible-operation processor device having two hemispheres that can be operated in series as a single-core device or in parallel as a multi-core device, etc.). For example, in some instances, a single-core processor device can include a processor device configured to receive a single set of instructions (e.g., compiled instructions, etc.) and to execute, in a serial or pipelined fashion using one or more functional units 202, a set of operations defined by the single set of instructions. For example, in some instances, a single-core processor device 201 can include a processor device configured to obtain (e.g., receive, retrieve, etc.) one or more instructions (e.g., SIMD instructions, etc.) indicative of a plurality of operations (e.g., plurality of SIMD operations, etc.) to be performed on one or more operands; and perform, in series using a plurality of functional units 202, the plurality of operations (e.g., SIMD operations wherein each operation is a multiple-data operation, etc.) on the one or more operands.

Functional unit(s) 202 can include, for example, one or more components (e.g., integrated circuit components, etc.) configured to perform operations on one or more operands (e.g., data operands, etc.). In some instances, functional unit(s) 202 can include deterministic functional units 202, such as deterministic functional units configured to perform one or more operations in a predetermined program order, according to a predetermined timing or temporal relationship, or the like. In some instances, a set of functional units 202 can include a plurality of dedicated or special-purpose functional units 202, such as distinct functional units 202 having distinct functions or sets of functions (e.g., limited or specialized function sets, etc.). In some instances, functional unit(s) 202 can include functional units configured to perform multiple operations per instruction for at least some instructions, such as single-instruction multiple-data (SIMD) functional unit(s) 202, and/or functional unit(s) 202 configured to process instruction(s) directed to multiple computing operations (e.g., multiple repetitions of a single type of operation, pipeline of multiple different operations, etc.).

In some instances, a set of dedicated functional unit(s) 202 can include distinct dedicated functional units 202 for each of a plurality of steps in a machine-learned inference pipeline, such as a distinct dedicated functional unit for each component of a category or type of machine-learned model layer (e.g., convolutional layer, attention layer, fully connected layer, etc.). For example, in some instances, a set of dedicated functional units 202 for implementing a fully connected layer of a machine-learned model can include one or more matrix functional units 209 for performing matrix multiplication between a parameter tensor (e.g., weight matrix, etc.) and a tensor (e.g., vector, etc.) of input values to the fully connected layer, and one or more vector functional units 210 for performing an activation function of the fully connected layer. As another example, in some instances, a set of dedicated functional units 202 for implementing a convolutional layer of a machine-learned model can include one or more permute/routing functional units 211 configured to perform one or more data reshaping operations corresponding to one or more convolutions (e.g., two-dimensional convolutions, one-dimensional convolutions, etc.); and one or more other functional units 202 (e.g., matrix functional unit(s) 209, vector functional unit(s) 210, etc.) for performing additional operations associated with a convolutional layer or convolutional neural network (e.g., matrix multiplication, pooling, activation functions, etc.).

In some instances, a plurality of dedicated functional units 202 can include a first functional unit 202 configured to perform a set of operations that is different (e.g., completely disjoint from or partially overlapping, etc.) from a second set of operations associated with a second functional unit 202. In some instances, a plurality of special-purpose or dedicated functional units 202 can have a plurality of distinct instruction set architectures, such as limited or special-purpose instruction set architectures each supporting a limited or special-purpose set of operations. As a non-limiting illustrative example, in some instances, a set of dedicated functional units 202 can include one or more of: a matrix functional unit 209 configured to perform a first set of matrix operations (e.g., matrix multiplication operations, etc.); a vector functional unit 210 configured to perform a set of vector operations different from the matrix operations (e.g., activation function operations such as rectified linear unit (ReLU), sigmoidal, SoftMax, or other activation function operations; normalization operations; etc.); a permute/routing functional unit 211 configured to perform one or more data routing, data permutation, or data reshaping functions (e.g., tensor permutation or reshaping, etc.) different from the matrix operation(s) and different from the vector operation(s); or other dedicated functional unit(s) 202. Other examples are possible.

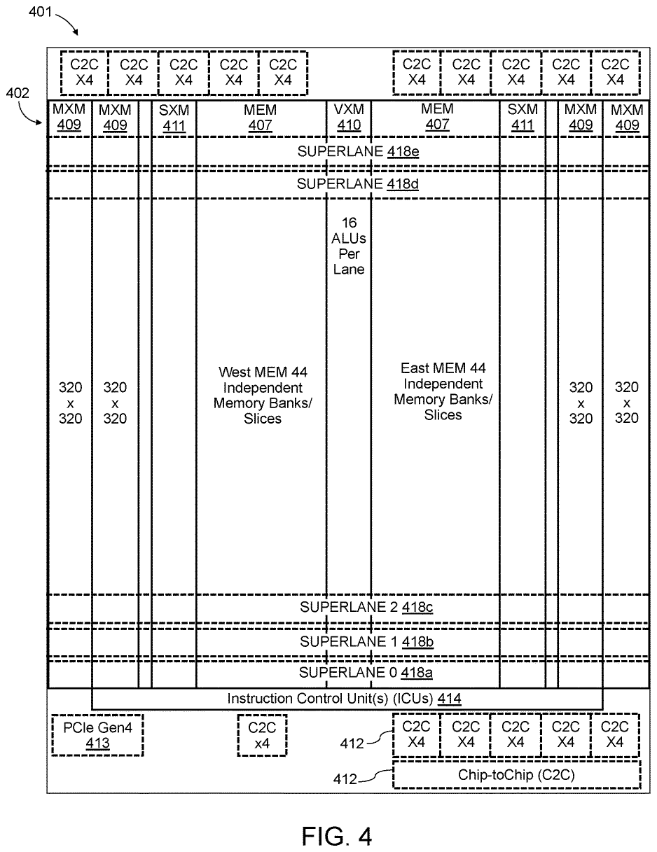

In some instances, functional unit(s) 202 can include functional units organized into functional regions of a processor die, such as compact functional regions configured to facilitate low-latency propagation of instructions or operands within a functional unit 202 or between adjacent functional units 202. As a non-limiting illustrative example, in some instances, one or more functional units 202 can be organized into functional slices along a first axis of a processor die, thereby enabling low-latency propagation of one or more instructions along the axis, low-latency propagation of operand data along a second axis, or the like. Further details of an example processor device including functional slices are provided below with respect to FIG. 4.

In some instances, functional unit(s) 202 or functional region(s) can be geographically organized on a processor die to reduce (e.g., minimize or nearly minimize; reduce relative to a random arrangement or relative to a conventional multi-core central processing unit or conventional graphics processing unit, etc.) a communication cost (e.g., latency cost, power cost, communication distance, etc.) associated with one or more computational pipelines, such as machine-learned inference pipelines. For example, in some instances, one or more functional units 202 or functional regions of a processor device 201 for performing a sequentially first operation in a computational pipeline can be geographically close to one or more functional units 202 for performing a sequentially second operation in the computational pipeline. Example computational pipelines can include, for example, inference pipelines associated with common machine-learned model, layer, or head architectures, such as convolutional architectures; attention architectures; fully connected layer architectures; selective structured state space machine architectures; gating architectures (e.g., long short-term memory, etc.); or another machine learning architecture.

In some instances, functional unit(s) 202 can include functional units configured to perform multiple operations per instruction for at least some instructions, such as single-instruction multiple-data (SIMD) functional unit(s) 202 or functional units 202 configured to operate without necessarily receiving explicit instructions for each operation. For example, functional unit(s) 202 configured to operate without necessarily receiving explicit instructions for each operation can include one or more of: functional unit(s) 202 configured to receive intermittent instructions and perform multiple operations per instruction (e.g., repeated single operation, pipeline of multiple different operations, etc.); functional unit(s) 202 configured to operate without instructions according to a default operation; or the like. In this manner, for instance, an amount of communication involved to provide instructions to the functional units 202 can be reduced, and operation of the processor device 201 can in some instances be simplified compared to some alternative implementations.

For example, in some instances, a SIMD functional unit 202 can include a tensor functional unit 208 configured to execute an instruction on a plurality of numerical values, such as a vector or matrix of numerical values. For example, in some instances, a tensor functional unit 208 can be configured to receive an instruction; and process, according to the instruction, a tensor (e.g., one-dimensional vector tensor, two-dimensional matrix tensor, etc.) including a plurality of numerical values (e.g., dozens of numerical values per instruction, such as hundreds of numerical values per instruction, such as 320 numerical values per instruction in some examples, such as those described below with respect to FIG. 4). In some instances, a tensor functional unit 208 can be configured to process some or all of a plurality of values simultaneously, or to execute a single-instruction multiple-data instruction according to a staggered timing.

As another example, in some instances, a functional unit 202 configured to operate based on intermittent instructions can include a functional unit 202 configured to repeat one or more operations, such as a functional unit 202 configured to continue performing a given operation (e.g., an operation associated with a most recently received instruction, etc.) periodically (e.g., at every clock cycle; at every Nth clock cycle; etc.) for some amount of time (e.g., indefinitely, for a finite period of time such as a time period defined by a previously received instruction, etc.) in the absence of explicit instructions. In some instances, a functional unit 202 can include a functional unit 202 configured to receive and execute one or more repetition instructions (e.g., having an instruction set architecture including one or more repetition instructions, etc.). A repetition instruction can include, for example, an instruction to cause the functional unit 202 to repeat (e.g., repeat at every clock cycle; at every Nth clock cycle, where N can be a parameter of the instruction; etc.) a previous instruction or set of instructions a number of times specified by the instruction; an instruction indicative of an operation to be repeated (e.g., arithmetic operation, matrix operation, vector operation, etc.), the instruction having a repetition parameter indicating a number of times to repeat the operation; or the like. In some instances, a repetition instruction can include one or more offset parameters, such as a time offset parameter (e.g., number of cycles to wait between repetitions, etc.), location offset parameter indicative of a distance between consecutive locations (e.g., functional unit 202 location, memory location, data path location, etc.) associated with a repeated operation, or other offset parameter.

As another example, in some instances, a functional unit 202 can include a functional unit 202 configured to receive a single instruction indicative of multiple distinct operations to be performed on a single operand or set of operands, such as a multiply-accumulate (MACC) instruction or matrix multiplication instruction indicative of one or more multiply operations and one or more accumulate operations to be performed on one or more outputs of the multiply operation(s). In some instances, a functional unit 202 can include a pipelined hardware architecture (e.g., systolic array pipelined hardware, deterministic streaming hardware such as hardware having one or more properties described with respect to FIG. 4, etc.) configured to provide (e.g., directly; indirectly via one or more buffers, registers, or other memory components; etc.) an output of one or more first hardware devices (e.g., floating-point units, etc.) for performing earlier (e.g., sequentially first, etc.) operations of a multi-operation instruction to an input of one or more second hardware devices for performing later (e.g., sequentially second or last, etc.) operations of the multi-operation instruction. In some instances, a pipelined hardware architecture of a functional unit 202 can include a geographically compact architecture, wherein a plurality of components for performing a multi-operation instruction can be adjacent or otherwise close together on a processor die.

An arithmetic functional unit 206 can include, for example, one or more functional units 202 for performing various arithmetic operations, such as floating-point operations, integer operations, or quantized operations; simple operations (e.g., add, multiply, format conversion, etc.) or complex/combined operations (e.g., multiply-accumulate, etc.); single-operand operations or multi-operand operations (e.g., tensor operations, etc.); or other arithmetic operations. In some instances, an arithmetic functional unit 206 can be a tensor functional unit 208 or component thereof, or have one or more properties described below with respect to tensor functional unit(s) 208.

A memory functional unit 207 can include, for example, one or more functional units 202 for reading, writing, or storing various kinds of data, such as operand data, instruction data, or other data. Data storage can include, for example, temporary storage of one-time-use or ephemeral values (e.g., computed operand values, etc.), longer-term storage of values to be reused (e.g., machine-learned model weights, compiled computer-executable instructions, etc.), or other storage. In some instances, a memory functional unit 207 can include one or more low-latency, high-bandwidth, or otherwise rapidly accessible memory devices, such as random access memory (RAM) devices (e.g., static random access memory (SRAM), high-bandwidth memory (HBM), dynamic random access memory (DRAM), etc.), registers, or other low-latency devices.

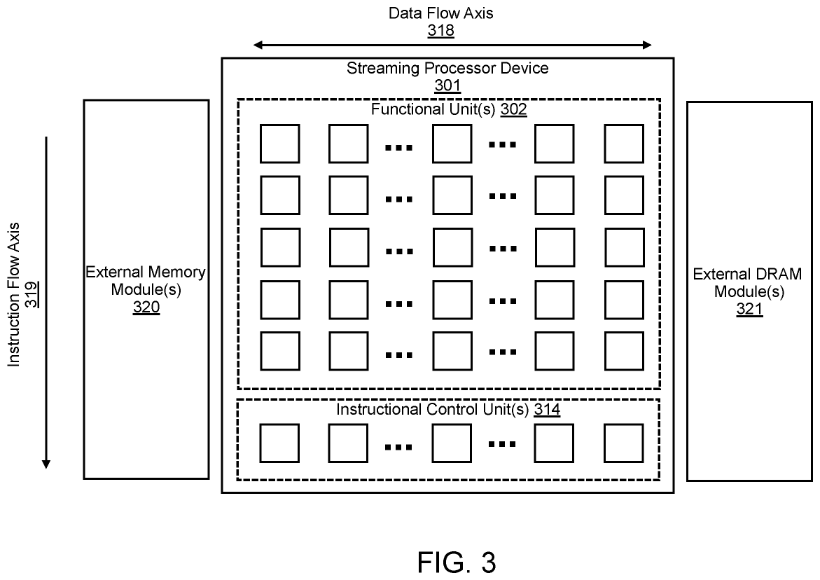

In some instances, one or more memory functional units 207 can be configured to share a global address space accessible to a plurality of functional units 202. For example, in some instances, a global address space can include all memory locations available to the processor device 201 (e.g., including any external memory units, etc.), such that any functional unit 202 of the processor device 201 can obtain (e.g., receive at a predetermined time defined by the compiler, such as without requiring the functional unit 202 to output any request for the data obtained). In some instances, a set of memory functional unit(s) 207 can include, or a processor device 201 can have access to, one or more internal (e.g., on-chip) memory functional units 207; one or more external (e.g., off-chip, near-compute, etc.) memory units; or both. Further details of some example near-compute external memory units are provided below with respect to FIG. 3, while details of some example on-chip memory units are provided below with respect to FIG. 4.

A tensor processing unit 208 can include, for example, a functional unit 202 to perform one or more operations (e.g., arithmetic operations such as tensor multiplication, elementwise multiplication, normalization, activation function operations, etc.) on one or more tensors (e.g., matrices, vectors, etc.). In some instances, a tensor processing unit 208 can include a matrix functional unit 209; a vector functional unit 210; or another functional unit.

A matrix processing unit 209 can include, for example, a functional unit 202 configured to perform one or more operations on a matrix (e.g., two-dimensional matrix, flattened matrix, etc.) of operands (e.g., numerical values such as floating-point values, etc.). In some instances, a matrix processing unit 209 can include a functional unit 202 configured to perform matrix multiplication or other matrix operations.

A vector processing unit 210 can include, for example, a functional unit 202 configured to perform one or more operations on a vector (e.g., one-dimensional vector, flattened tensor, etc.) of operands (e.g., floating-point numerical values, etc.). In some instances, a vector processing unit 210 can include a functional unit 202 configured to perform one or more of: one or more activation function operations (e.g., sigmoidal or logistic activation function, linear unit activation function such as rectified linear unit (ReLU), SoftMax activation function, etc.), one or more normalization operations (e.g., L2 normalization, etc.), one or more combining operations (e.g., attention-based combining, etc.) to combine a set (e.g., pair, trio, etc.) of vectors, one or more constituent operations configured to be combined to support a class of related operations (e.g., class or category of normalization operations, class or category of activation function operations, etc.), or the like.

A permute/routing functional unit 211 can include, for example, a functional unit 202 configured to perform one or more data permuting or data routing operations. In some instances, a data permuting operation can include one or more swap or reordering operations configured to reorder data in an ordered format (e.g., vector format or other tensor format; ordered arrangement of registers, signal lines, or other hardware units; etc.), such as without changing a shape (e.g., length, width, number of dimensions, etc.) of the ordered format. Example reordering operations can include, for example, rotation or translation operations; arbitrary reordering operations defined by one or more reordering maps such as a gather map; or other reordering operations. In some instances, a data permuting operation can include a reshaping operation, such as a reshaping operation changing a number of dimensions of a data structure (e.g., tensor, hardware devices corresponding to a tensor, etc.), changing a size of one or more dimensions of the data structure, or the like. As a non-limiting illustrative example, in some instances, a reshaping operation can include a tensor flattening operation to convert a multi-dimensional tensor into a one-dimensional data structure (e.g., vector, hardware configuration corresponding to a vector, one-dimensional data stream corresponding to a vector, etc.). As another example, in some instances, a reshaping operation can include an expansion or duplication operation, such as a reshaping operation to generate an expanded convolutional kernel to implement a filter component of a convolutional neural network. In some instances, a routing operation can include a permuting operation to change an ordering of operands input to one or more fixed or predetermined data paths, or another routing operation (e.g., switching operation; pair of operations including a send and a receive; etc.). In some instances, a permuting operation can include a routing operation to change a routing of operands to hardware having a fixed or predetermined input order.

In some instances, a memory functional unit 207; a tensor, matrix, or vector functional unit 208, 209, 210; or a permute/routing functional unit 211 can be or include a deterministic functional unit 202 configured to execute instruction(s) at a predetermined time defined by a compiler; a single-instruction multiple-operation functional unit 202 configured to perform a plurality of operations based on one instruction; or have any other property described herein with respect to functional unit(s) 202. Further details of some example functional units 207, 209, 210, 211 are provided below with respect to FIG. 4.

Communication units 203 can include various components for performing communication operations (e.g., input, output, etc.) between the processor device 201 and other devices (e.g., processor devices, computing devices, external memory devices, etc.) or components, or within the processor device 201. In some instances, communication units 203 can include deterministic communication units (e.g., communication units performing operations according to a predetermined program order, timing, temporal relationship, or other predetermined property, etc.), non-deterministic communication units (e.g., communication units having non-deterministic timing properties, communication units configured to communicate with non-deterministic external devices, etc.), or both. For example, in some instances, a deterministic processor device 201 can include a plurality of deterministic chip-to-chip communication links 212 configured to communicate with other deterministic processor devices 201 (e.g., using deterministic communication operations having a predetermined timing, communication path, or other property), along with one or more PCIe components 213 configured to interact with one or more non-deterministic components. In some instances, communication units 203 can include or have access to various components, such as serializer-deserializer (SerDes) units configured to serialize data to be output or deserialize data received as input; communication ports, connections, interface units, or the like; communication lines (e.g., electrically conductive signal traces, electrically conductive wires, optical fibers, cables, etc.); routing or data permutation components (e.g., internal routing or permutation components such as switching components; external components coupled to the processor device 201 such as routers, repeaters, switches, panels, or the like); or other components configured to facilitate one or more communication operations.

Chip-to-chip communication units 212 can include, for example, any device or component for communicating with another processor device (e.g., processor device 201, etc.), such as one or more serializer-deserializer units, one or more communication channels (e.g., signal lines, etc.), one or more connection components (e.g., ports, pins, connection pads, etc.), or the like. In some instances, a processor 201 can include a plurality of chip-to-chip communication ports to facilitate direct communication with a plurality (e.g., four, eight, sixteen, etc.) of other chips, such as according to a high-radix chip-to-chip communication topology (e.g., dragonfly topology, HyperX topology, etc.), such as a topology having greater than or equal to eight chip-to-chip communication links per processor device 201. In some instances, chip-to-chip communication units 212 can include units configured to communicate with processor devices that are geographically close to or far away from the processor device 201 (e.g., in a same or different compute node as the processor device 201; in a same or different rack; etc.). In some instances, chip-to-chip communication units 212 can include connections to a plurality of distinct chips, a plurality of connections to a single chip, or both. In some instances, chip-to-chip communication units 212 can include chip-to-chip communication units 212 associated with one or more bidirectional communication channels, one or more unidirectional communication channels, or both. In some instances, chip-to-chip communication units 212 can include deterministic communication units configured to perform chip-to-chip communication operations (e.g., send operation, receive operation, etc.) at one or more times predetermined by a compiler; deterministic communication units having a known or deterministic timing for one or more data transfer operations; or the like. In some instances, one or more timing units 205 can be used to provide synchronization for one or more processor devices 201 to facilitate deterministic-timing communication between chips.

A peripheral component interconnect express (PCIe) component 213 can include, for example, a communication device configured to facilitate communication between a processor device 201 and one or more other devices (e.g., computing devices; processor devices; data storage devices; auxiliary devices; etc.). In some instances, a PCIe unit 213 can include a communication system conforming to one or more PCIe communication standards (e.g., PCIe 6.0, PCIe 7.0, etc.). Although FIG. 2 depicts a PCIe unit 213, other communication units or communication standards can be used without deviating from the scope of the present disclosure. In some instances, a processor device 201 can include a deterministic processor device 201 configured to communicate non-deterministically via the PCIe unit 213 while maintaining determinism in the functional unit(s) 202 of the processor device 201 (e.g., according to methods described above).

In some instances, control unit(s) 204 can include one or more devices for controlling one or more operations of the functional unit(s) 202, such as device(s) configured to supply one or more control signals (e.g., assembly code or machine code instructions; switching signals, multiplexer selection signals, etc.) to one or more functional unit(s) 202.

In some instances, control unit(s) 204 can include one or more instruction control unit(s) 214 configured to supply computer-executable instruction(s) to one or more functional units. In some instances, an instruction control unit 214 can include a deterministic instruction control unit 214 configured to supply instruction(s) to the functional unit(s) 202 according to a predefined program order determined by the compiler; supply instruction(s) at one or more predefined times (e.g., clock cycles, etc.); or the like. In some instances, an instruction control unit 214 can include hardware configured to fetch (e.g., prefetch, etc.) instruction(s) from memory at a first time (e.g., before the instructions are needed; during a time of off-peak memory usage; at a time predetermined by a compiler; etc.) and provide corresponding instruction(s) to one or more functional unit(s) 202 at a second time (e.g., second time predetermined by the compiler, etc.)

In some instances, instruction(s) provided to a functional unit 202 by an instruction control unit 214 can be the same as or different from a corresponding instruction received by the instruction control unit 214. For example, in some instances, an instruction control unit 214 can include a unit configured to translate one or more compiled instructions (e.g., instructions in a first computing language or format output by a compiler, etc.) to one or more control signals (e.g., instructions in a second language or format; other control signals such as multiplexer selection signals or the like). In some instances, translating compiled instructions can include translating a memory-efficient stored instruction to a plurality of control signals that may include a greater data volume than the memory-efficient stored instruction. For example, in some instances, translating compiled instructions can include retrieving, from a memory functional unit 207, a compiled instruction; and providing, based on the compiled instruction, a plurality of control signals to one or more (e.g., a plurality of) functional units 202 over one or more (e.g., a plurality of) clock cycles. In some instances, a memory-efficient stored instruction can include a multi-operation instruction associated with a plurality of related operations (e.g., operations of a machine-learned model layer such as matrix multiplication, activation functions, convolution, attention, or the like), and the translated control signals can include a plurality of control signals (e.g., lower-level instructions, etc.) for executing the multi-operation instruction. In some instances, an instruction control unit 214 can include hardware configured to receive an instruction including one or more timing parameters (e.g., delay amounts, etc.) or repetition parameters, and output control signal(s) to the functional unit(s) 202 to cause the functional units to perform operations according to the timing or repetition parameters (e.g., at a predetermined clock cycle defined by a compiler, etc.). In some instances, the instruction control unit 214 can control a timing or a number of repetitions of the functional unit(s) 202 by sending control signals including timing or repetition data, or by sending raw control signals at a specific time or plurality of times configured to cause the functional unit(s) 202 to perform operations according to one or more timing or repetition parameters.

In some instances, timing and synchronization units 205 can include various components configured to perform synchronization operations, such as operations to track or communicate time data (e.g., current clock cycle data, etc.) to one or more functional units 202 or other components of a processor device 201. In some instances, timing and synchronization units 205 can include one or more of: one or more hardware-aligned counters 215, one or more software-aligned counters 216, or other timing or synchronization component.

Hardware aligned counters 215 may be used to establish a time base for electronic circuitry in each system, such as a clock, for example. Additionally, each system may include software aligned counters 216. Software aligned counters 216 may be synchronized, for example, based on one or more computer-executable instructions (e.g., compiled instructions determined by a compiler, etc.). Hardware aligned counters 215 and software aligned counters 216 may be implemented as digital counter circuits, for example, on each integrated circuit (e.g., each processor device 201 or each die thereof, etc.). For instance, hardware aligned counters 215 may be free-running digital counters (e.g., 8-bit counters) on a processor device 201 that are synchronized periodically. Similarly, software aligned counters 216 may be digital counters (e.g., 8-bit counters) that synchronized based on timing markers triggered by one or more compiled programs.

In some instances, timing and synchronization units 205 can include one or more components 205 for internal synchronization of a plurality of components (e.g., functional units 202, etc.) of a processor device 201; one or more components 205 for external synchronization between a first processor device 201 and one or more other devices (e.g., a plurality of second processor devices 201, etc.); or both.

In some instances, synchronizing a first device (e.g., first processor device 201 or another device) with a second device (e.g., second processor device 201 or another device, etc.) can include, for example, synchronizing one or more hardware aligned counters 215 of the first processor device 201 with one or more hardware aligned counters of the second device. Synchronizing the hardware aligned counters 215 may occur periodically during the operation of each system and may occur at a higher frequency than synchronizing software counters 216, for example. Synchronizing hardware counters may include the first device sending a timing reference (e.g., timing bits representing a time stamp) to the second device over a communication channel (e.g., via chip-to-chip communication units 212, etc.). In some instances, a first system may send an 8-bit time stamp, for example. In such a scenario, a hardware counter 215 and software counter 216 of the first device may be maintained in sync locally. However, as the hardware counter 215 on a second device is synchronized to the hardware counter 215 on a second device, the software counter 216 on the second device may drift.

In some instances, software aligned counters 216 of a pair of devices can be synchronized by providing, in each of the devices (e.g., as part of a compiled program executed by the devices, etc.), one or more timing markers configured to be sequentially triggered (e.g., at predetermined positions in a compiled program corresponding to particular points of time or particular cycles). In some instances, timing markers in each device may be configured to trigger on the same cycle in each system. For example, a first program on a first device may trigger a timing marker on the same cycle as a second program on a second device when the devices' hardware aligned counters 215 are synchronized. In some instances, these timing markers may be used to synchronize software counters 216 of both devices. For example, in some instances, timing differences between the timing markers may correspond to a time difference indicative of a degree to which the two devices are out of synchronization, and synchronization can include adjusting a timing of one or more operations based on the time difference. For example, in some instances, a software aligned counter 216 can perform one or more delay operations at each of a plurality of timing markers, and a length of the delay can be adjusted based at least in part on a time difference between the first and second device at the timing marker. However, same-cycle timing is not necessarily required; for example, in some instances, a pair of timing markers may be offset by a known number of cycles, which may be compensated for during the synchronization process (e.g., by using different fixed delays, etc.).

In some instances, a timing difference (e.g., number of cycles, etc.) between timing markers may be constrained within a range. For example, a minimum time difference between timing markers in a first and second device may be based on a time to communicate information between the devices (e.g., a number of cycles greater than a message latency), and a maximum time difference between timing markers in the devices may be based on a tolerance of oscillators forming the time base on each system (e.g., if the time difference increases beyond a threshold for a given time base tolerance, it may become more difficult or impossible for the systems to synchronize for a given fixed delay). The minimum and maximum number of cycles may also be based on the size of a buffer (e.g., a first in first out (FIFO) memory) in each chip-to-chip communication circuit, for example.

In some instances, synchronizing hardware aligned counters 215 of a pair of devices can include sending, by a first device at a first time to, a timing reference; and receiving, at a second time t₁ by a second device, the timing reference. In some instances, the latency of such a transmission may be characterized and designed to be a known time delay Δt=t₁−t₀. In such instances, synchronizing the pair of devices can include setting, by the second device, a hardware aligned counter 215 to a value of (t₀+Δt) such that the hardware aligned counters 215 of both devices are synchronized.

In some instances, although the first and second devices can be architecturally similar (e.g., same) or different, synchronizing the devices can include, for example, assigning a first device as a designated sender device to send timing data, and designating a second device as a designated receiver device to receive timing data and adjust a timing of the receiver device's operations based on the timing data.

In some instances, software aligned counters 216 can be synchronized in a manner similar to synchronization of hardware aligned counters 215. For example, in some instances, a software aligned counter 216 can include or implement one or more timing triggers including one or more delays (e.g., no-operation (NOP) delays, etc.), wherein a plurality of devices are configured to perform a synchronized delay, such that one or more operations performed after the synchronized delay may be synchronized. For example, in some instances, a first device may send timing data to a second device at t0; and perform a predefined delay operation until t1. A second device may receive the timing data at (t0+Δt); and determine, based on the timing data, an amount of delay (e.g., number of clock cycles, etc.) to cause the second device to resume operations at t1.

In some instances, synchronization can include fine synchronization (e.g., as described above), coarse synchronization, or both. For example, during various points in operation, the first and second systems may be far out of sync. For example, during startup or after a restart (collectively, a “reset”), a set (e.g., pair, etc.) of devices may perform a coarse synchronization (e.g., using a 20-bit digital counter, etc.) to bring the time bases close enough so they can be maintained in alignment using the techniques described above (e.g., within a resolution of the hardware and software counters, such as 8 bits).

In some instances, synchronizing a number of devices greater than two can include performing similar operations with more than two devices, such as pairwise synchronizations at staggered times, such as pairwise synchronization of a processor device 201 with each of a plurality of neighbors in a chip-to-chip communication topology at a plurality of respective times; one-to-many (e.g., one-to-all, etc.) broadcasting of timing data; pairwise propagation of timing data between pairs of devices according to a propagation pattern or communication topology; or other mechanism for sending and receiving timing data and updating a timing of operations based on the timing data.

FIG. 3 is a block diagram of an example processor device 301 including a plurality of functional units 302 and a plurality of instruction control units 314. In some instances, processor device 301 can be configured to transmit (e.g., stream, propagate, etc.) operand data along a data flow axis 318 and transmit instruction data along an instruction flow axis 319. In some instances, the processor device 301 can be configured to perform one or more deterministic data flow operations, such as transmitting (e.g., streaming, etc.) operand data and instruction data at one or more predetermined times defined by a compiler, such that a compiler can control a timing of operand and instruction data flow to cause an instruction and corresponding operand(s) to intersect at a functional unit 302 for executing the instruction at a predetermined time (e.g., clock cycle) selected by the compiler. In some instances, a processor device 301 can be configured to access one or more external memory units 320 (e.g., near-compute external memory units 320, etc.), such as one or more external dynamic random access memory (DRAM) units 321.

In some instances, a processor device 301 can be, comprise, be comprised by, or otherwise share one or more properties with a processor device 201. For example, in some instances, a processor device 301 can have any property described herein with respect to a processor device 201, and vice versa.

In some instances, a functional unit 302 can be, comprise, be comprised by, or otherwise share one or more properties with a functional unit 202. For example, in some instances, a functional unit 302 can have any property described herein with respect to a functional unit 202, and vice versa.

In some instances, a data flow axis 318 can include a direction, axis, or path along which operand data can flow. For example, in some instances, one or more functional units 302 can be configured to receive one or more input operands along the data flow axis; process the input operands to generate one or more output values; and transmit the output values along the data flow axis 318 to another functional unit 302, which can use the output values as input operands, and so on. In some instances, functional units 302 configured to perform related operations (e.g., pairs of operations associated with some machine-learned inference pipelines, etc.) can be located close together along the data flow axis 318; ordered along the data flow axis in an ordering corresponding to an ordering of one or more sets of related operations; or otherwise geographically arranged on a processor die to reduce a cost (e.g., latency, power cost, etc.) or increase a performance (e.g., throughput, etc.) of one or more operations (e.g., machine-learned inference operations, etc.). For example, in some instances, a series of related operations for machine-learned inference can include one or more of: matrix multiplication (e.g., multiplying machine-learned model parameters by input activations, etc.), activation function operations, mixing or combining operations (e.g., attention-based mixing, etc.), preprocessing or postprocessing operations, or other operations. In some instances, an ordering of such operations can include an ordering associated with one or more of: a transformer layer; a fully connected layer; an attention head; a convolutional layer; a pooling layer; a recurrent layer; a gating layer; or other machine learning architecture component. In some instances, a data flow axis 318 can include a physical axis or a logical axis, such as an operand flow path that may include or not include a straight-line operand flow path. In some instances, all or part of a data flow axis 318 can be orthogonal (e.g., logically orthogonal, physically orthogonal, etc.) to an instruction flow axis 319.

In some instances, an instruction flow axis 319 can include a direction, axis, or path along which instruction data can flow. For example, in some instances, an instruction control unit 314 can be configured to provide, to one or more first functional units 302, an instruction; and the first functional unit(s) 302 can be configured to execute the instruction and/or pass the instruction along to neighboring functional units 302 along the instruction flow axis 319. In some instances, a plurality of neighboring functional units along the instruction flow axis 319 can include a plurality of functional units 302 performing similar (e.g., same) functions, such as a plurality of memory functional units or the like. In some instances, a plurality of neighboring functional units along the instruction flow axis 319 can include a plurality of functional units 302 configured to execute the same instruction received from an instruction control unit 314 and propagated along the instruction flow axis. In some instances, an instruction flow axis 319 can include a physical axis or a logical axis, such as an operand flow path that may include or not include a straight-line operand flow path. In some instances, all or part of an instruction flow axis 319 can be orthogonal (e.g., logically orthogonal, physically orthogonal, etc.) to a data flow axis 318.

In some instances, a processor device 301 can include a deterministic processor device 301 including a plurality of deterministic functional units 302 configured to perform one or more operations at a predetermined time defined by a compiler at compile time. In some instances, a compiler can control a timing of one or more instruction and data flows to cause one or more instructions traversing the instruction flow axis 319 to intersect one or more operands traversing the data flow axis 318 at a functional unit 302 scheduled to execute the instruction(s) on the operand(s) at a predefined time instant selected by the compiler.

In some instances, a processor device 301 can include a plurality of functional tiles 302, which can include functional units 302 arranged in a tiled arrangement on a processor die. The functional tiles 302 can perform various functions such as vector-matrix multiplication, switching of data along different circuit pathways, and local data storage and retrieval. In some instances, functional tiles 302 can share a common system clock. In some instances, functional tiles 302 can include one or more sets of interconnected functional tiles 302 processing the same data, such as interconnected functional tiles 302 that are adjacent along a data flow axis 318; at a same location along an instruction flow axis 319; or the like. In some instances, a plurality of interconnected functional tiles 302 processing the same data can be referred to herein as a “lane” or “Superlane.” For example, in some instances, each functional tile 302 in a Superlane can be subdivided into 16 sub-tiles, and a set of subtiles processing the same data can be referred to herein as ‘lanes’. A set of data that is processed by one Superlane is referred to herein as a ‘stream’. In some instances, each lane in a tile of a Superlane can be configured to process one byte (e.g., one byte per clock cycle, one byte at a time, etc.).

In some instances, an instruction control unit 314 can be, comprise, be comprised by, or otherwise share one or more properties with an instruction control unit 214. For example, in some instances, an instruction control unit 314 can have any property described herein with respect to an instruction control unit 214, and vice versa.

In some instances, data between two adjacent functional tiles 302 can flow bidirectionally, or can primarily (e.g., most or all of the time) move in one direction along a lane or Superlane. In some instances, a first Superlane can have a direction of flow along the data flow axis 318 that is the same as or different from a direction of flow of a second Superlane. In some instances, operand data can be transferred along the data flow axis 319 at every clock cycle of a processor device 301. In some instances, when processing of operand data is complete in one Superlane, the data can be either returned to a host computer including the processor device 301 or transferred (e.g., by permute/routing functional units 211, etc.) to another Superlane for additional processing.

In some instances, a Superlane can process streams of data in 16 lanes. In some instances, each instruction can be performed on all 16 lanes at once, and then, if required by the instructions being executed, in the next Superlane in a subsequent cycle, and so forth. For example, in some instances, if a processor device 301 contains N (e.g., 20, etc.) adjacent Superlanes, then an instruction can be passed to N adjacent functional tiles 302 (e.g., over the course of N clock cycles, etc.), and each instruction can execute on all 16*N (e.g., 320) lanes across the N Superlanes. In some instances, a processor device 301 architecture can include an architecture that lacks register files, and a compiler can schedule the streaming data to be available to the functional tile 302 at a predetermined designated time to execute a designated instruction.

An external memory unit 320 can include, for example, a memory device that is external to the processor device 301, such as a memory device on a separate die from the processor device 301 or the like. In some instances, an external memory unit 320 can have one or more properties that are the same as or different from one or more properties of a memory functional unit 207. For example, in some instances, an external memory unit 320 can include any memory type or device type described herein with respect to a memory functional unit 207. As another example, in some instances, an external memory unit 320 can use a first type of memory that is different from a second type of memory used in an on-chip memory functional unit 207. For example, in some instances, a memory functional unit 207 can include a low-latency memory type such as SRAM, and an external memory unit 320 can use one or more lower-cost or higher-storage-capacity memory types, such as dynamic random access memory (DRAM). Other memory types are possible without deviating from the scope of the present disclosure (e.g., SRAM or other non-volatile memory (NVM) such as 3D NOR memory, NAND memory, FLASH memory, phase change memory such as 3D Crosspoint memory, a next-generation ferroelectric memory, or a Nanotube RAM, etc.). For example, in some instances, an external memory unit can have any property described herein with respect to an external dynamic random access memory (DRAM) unit 321, and vice versa.

In some instances, an external dynamic random access memory (DRAM) unit 321 can include one or more dynamic random access memory (DRAM) components, such as double data rate synchronous DRAM (DDR) such as DDR5, low-power double data rate synchronous DRAM (LPDDR), synchronous DRAM (SDRAM), low-random-transaction-rate DRAM having a low random transaction rate relative to one or more other memory device types (e.g., SRAM, etc.), or other DRAM component(s).

In some instances, an external memory unit 320, 321 can include a deterministic memory device configured to perform one or more operations at a predetermined time defined by a compiler at compile time; a deterministic memory device having a known or constant latency for one or more operation types (e.g., read latency, write latency, etc.); or the like.

In some instances, an external memory unit 320, 321 can include a plurality of memory banks, wherein each bank has a plurality of rows for storing data. Each memory bank can be addressable by a processor device 301 for writing data to selected rows in selected banks and for reading data from selected rows in selected banks, wherein data can be read a predetermined time-period before the data is required to arrive at one or more compute element(s) of the processor 301 and data can be written to a memory at a first pre-determined time-period that does not coincide with a memory refresh scheduled to occur at a second predetermined time.

In some instances, an external memory unit 320, 321 can include various features to provide high-bandwidth memory access, high levels of memory concurrency, or the like. For example, in some instances, an external memory unit 320, 321 can provide deterministic memory access functions (e.g., deterministic-latency operations, etc.) to provide for a compiler to control a timing of a plurality of data read, write, or refresh operations; control a level of memory concurrency for accessing a plurality of operands or other data from an external memory unit 320, 321; or other memory control functions. As another example, in some instances, an external memory unit 320, 321 can include a plurality of concurrently accessible memory banks (e.g., memory banks configured to be active simultaneously, etc.), thereby increasing a memory bandwidth of the external memory unit 320, 321. In some instances, an external memory unit 320, 321 can be configured to access a full row of memory (e.g., without reference to a column decoder, etc.) at each read or write operation. In some instances, a compiler can provide explicit control of memory location allocations, data path routing, and the like to increase (e.g., maximize or nearly maximize, increase relative to partial-row memory access, etc.) a level of memory concurrency of external memory unit 320, 321 operations.

In some instances, an external memory unit 320, 321 can include a deterministic memory unit having low-random-transaction-rate (low-RTR) memory (e.g., DRAM banks, etc.), and a processor device 301 can provide one or more deterministic operations to reduce (e.g., eliminate, etc.) a need for or usefulness of high-RTR memory. For example, in some instances, a plurality of simultaneously active low-RTR memory banks can be used to provide memory access having one or more performance properties (e.g., bandwidth, latency, etc.) equivalent to high-RTR memory.

In some instances, an external memory unit 320, 321 can have one or more features to reduce a power consumption of the external memory unit 320, 321 compared to some alternative implementations. For example, in some instances, an external memory unit 320, 321 can be placed in close proximity to a processor device 301 to reduce (e.g., minimize or nearly minimize) an amount of power consumed in reading or writing data to the memory unit 320, 321 (e.g., due to lower capacitive loading of short signal traces, etc.). In some instances, placing an external memory unit 320, 321 in close proximity to a processor device 301 can include connecting the unit 320, 321 to the processor device 301 in various manners, such as by face-to-face coupling (e.g., using wafer stacking technology, etc.) or another connection technique (e.g., passive interposer, active interposer, etc.). In some instances, a low-power external memory unit 320, 321 can include a memory component (e.g., DRAM component) having sense amps attached directly to row input/output (e.g., without a logic layer or without data buffer(s), etc.).

In some instances, an external memory unit 320, 321 can include one or more logic dies and a plurality of memory banks, such as a logic die coupled to a plurality of DRAM banks by through-silicon via and to a processor device 301 in a face to face configuration, etc. In some instances, a logic die can include row buffers for interfacing the processor device 301 to one or more memory components. The memory component(s) can also have an array core and a row decoder. During a read operation, the row decoder can select a row of array core and the entire row from the selected row can be transferred from the memory component to row buffers on the logic die. In some instances, a memory component or an external memory unit 320, 321 can lack column decoders and can read or write an entire row during each R/W cycle. In some instances, a memory plane can include 3D NOR memory.

In some instances, an external memory unit 320, 321 can provide a global address space available to a plurality of functional units 302. For example, in some instances, global memory access can be facilitated by one or more permute/routing functional unit(s) 211 of a processor device 301 to provide for any processor 301 component at any location on a die to access data residing in any memory bank element of an external memory unit 320, 321 or memory functional unit 207.

For example, in some instances, a streaming processor device 301 can provide operand data movement along a data flow axis 318 automatically (e.g., at every clock cycle, etc.), while one or more permute/routing functional unit(s) 211 can provide (e.g., responsive to one or more compiled instructions, etc.) operand data movement along an instruction flow axis 319. Further details of an example permute/routing functional unit 211 providing operand data movement along an instruction flow axis 319 are provided below with respect to FIG. 4.

In some instances, a processor device 301 can have sufficient permute/routing functional unit(s) 211 or data flow operations (e.g., routed data flow, automatic or unrouted data flow, etc.) to provide any retrieved data to be mapped to any functional unit 202 or port thereof. In some instances, permute/routing functional unit(s) 211 can provide additional operations in association with memory retrieval, such as data reshaping, padding (e.g., padding a size of a tensor by adding a plurality of zeros, etc.), duplication, or other data routing operations.

In some instances, a processor device 301 and external memory unit 320, 301 can operate deterministically (e.g., with deterministic timing, order of operations, etc.), and can have various features to take advantage of such determinism. For example, in some instances, a deterministic processor device 301 can initiate one or more data retrieval operations at a predetermined time period before the retrieved data is required to arrive at one or more corresponding compute elements. This can be used, for example, in combination with slow dense memory that may not necessarily provide low-latency or high-RTR performance of individual read operations, as read operations can be scheduled sufficiently far in advance to provide lower-RTR memory device(s) to perform similarly to a high-RTR memory of some alternative implementations. As another example, in some instances, given a processor device 301 that is deterministic, an external memory unit 320 can perform non-destructive row reads, as each row can write new data if aligned with a closing row. This can provide for, for example, improved performance, reduced power usage, or both. In some instances, a deterministic processor device 301 can deterministically write new data or deterministically refresh existing data to the row of the DRAM, thereby enabling higher write bandwidth and better management of a refresh function. In some instances, a refresh function can be performed with new data by accessing a DRAM write register loaded with new data. In some instances, the processor device 301 can also treat the external memory unit(s) 320, 321 as a circular read/write access medium having an opportunity to read and write every row location. For example, a row address line of an off-chip deterministic near-compute memory unit 320, 321 can be coupled to a clock. The row address line can be configured to receive a row address from the processor device 301 and increment every clock cycle in accordance with the circular medium access until the row address loops back without explicit addressing. This pattern can provide for even further power reduction and performance improvement while implicitly incorporating refresh support.

In some instances, a processor device 301 can use one or more memory functional unit(s) 207 (e.g., SRAM units, etc.) or another buffer device (e.g., external SRAM units interposed between a processor device 301 and external DRAM unit 321, etc.) as a buffer to temporarily store data retrieved from the external memory unit(s) 320, 321, or the processor device 301 can be configured to provide retrieved data directly to one or more functional unit(s) 302 for processing or routing (e.g., traversal of a data flow axis 318, etc.).

FIG. 4 is a block diagram of an example language processing unit device 401 according to example implementations of aspects of the present disclosure. The language processing unit (LPU) device 401 can include a plurality of functional slices 402, along with a plurality of data paths 418a, b, c, d, e between the functional slices 402. In some instances, the functional slices 402 can include one or more vector functional slices 410, one or more memory functional slices 407, one or more permute/routing functional slices 411, and one or more matrix functional slices 409. In some instances, a language processing unit 401 can further include a plurality of communication units 203 (e.g., PCIe unit(s) 413, chip-to-chip communication unit(s) 412, etc.); a plurality of instruction control unit(s) 414; or other component(s).

In some instances, one or more of a processing device 401, functional unit 402, communication unit(s), memory functional unit 407, matrix functional unit 409, vector functional unit 410, permute/routing functional unit 411, chip-to-chip link 412, PCIe 413, or instruction control unit 414 can be, comprise, be comprised by, or otherwise share one or more properties with a component having a similar (e.g., same, etc.) name or part number described herein with respect to another Figure, such as FIG. 2 or 3. For example, in some instances, a processing device 401 can have any property described herein with respect to a processing device 201 or processing device 301, and vice versa; a functional slice 402 can have any property described herein with respect to a functional unit 202 or functional unit 302, and vice versa; and so on.

In some instances, a processor device 401 can include one or more functional regions or sets of functional units 402 with the same functionality executing the same instructions, such as functional tiles 402 located in similar positions in different Superlanes (e.g., at a same point along a data flow axis 318, etc.). In some instances, such a functional region or set of functional units 402 with the same functionality executing the same instructions can be referred to herein as a functional ‘slice.’ In some instances, a processor device 401 can include one or more sets of directly connected slices of the same functional units, encompassing all the Superlanes, is referred to herein as a ‘partition’.

In some instances, a LPU 401 can include a plurality of slices, wherein each slice in a LPU can perform any of a variety of functions under the control of instructions transferred from buffers in the Instruction Control Unit 414. For example, in some instances, functional slices 402 can include memory functional slices 407 for memory storage and retrieval for data in a Superlane (MEM); functional slices 402 (e.g., matrix or vector functional slices 409, 410, etc.) for integer (INT) arithmetic or floating point (FPU) arithmetic; or permute/routing functional slices 411 for transferring data between Superlanes (NET or SXM). In some implementations, each of the functional slices 402 can operate independently, and operations of different functional slices 402 can be coordinated using barrier-like synchronization instructions.

For example, the memory functional slices 407 can perform Read and Write operations but not Add or Mul, which can in some instances be performed only in matrix functional slices 409 and vector functional slices 410. In some instances, all of a plurality of tiles in a functional slice 402 can execute the same set of instructions, so it is possible to locate all of the common instruction decode and dispatch logic into the ICU 414, and partition the normal instruction execution pipeline into two sets of instructions: (i) instruction fetch, decode, and parceling and (ii) operand read, execute, and writeback. Functional slices 402 or components thereof can operate without having to receive explicit instructions, or only receiving intermittent or limited instructions, from the ICU when the tiles are dedicated to a specific function, potentially simplifying operation of the processor.

In some instances, a functional slice 402 can include a plurality of functional tiles 302 (e.g., tiles organized along an instruction flow axis 319, etc.). In some instances, functional tiles in the same functional slice 402 (but not necessarily the same Superlane) can execute instructions in a “staggered” fashion where instructions are issued tile-by-tile within the slice over a period of N cycles. For example, the ICU 414 for a given slice may, during a first clock cycle, issue an instruction to a first tile of the slice (e.g., the tile directly connected to the ICU of the slice), which is passed to subsequent tiles of the slice along an instruction flow axis 319 over subsequent cycles.

In some instances, a processor device 401 can include a first and second matrix functional slice 409 or first and second set of matrix functional slices 409; a first and second permute/routing slice 411 or first and second set of permute/routing slices 411; a first and second memory slice or first and second set of memory slices 407; and a first vector functional slice 410. For example, in some instances, each Superlane can include a first set and second set of matrix multiplication tiles (MXM1 and MXM2), a first and second set of data path switching tiles (SXM1 and SXM2), a first and second set of memory tiles (MEM1 and MEM2), and a first set of vector calculation tiles (VXM1), wherein just one tile in MXM1 transfers data with one tile in SXM1, wherein just one tile in SXM1 transfers said data with just one tile in MEM1, wherein just one tile in MEM1 transfers said data with just one tile in VXM1, wherein just one tile in VXM1 transfers said data with just one tile in MEM2, wherein just one tile in MEM2 transfers said data with just one tile in SXM2, and wherein just one tile in SXM2 transfers said data with just one tile in MXM2.

In the above example, data transfers are entirely in one direction, for example MXM1 to SXM1 to MEM1 to VXM1 to MEM2 to SXM2 to MXM2. However, in other examples, data transfers can occur in multiple (e.g., two, etc.) directions, for example, one set of data transfers from VXM1 to MEM1 to SXM1 to MXM1, and another set of data transfers from VXM1 to MEM2 to SXM2 to MXM2.

In some instances, each Superlane, and in some instances the entire LPU 401, can execute a single set of instructions, such that the LPU 401 may be considered as a single processor core. However, in some instances, the LPU 401 Superlanes can be partitioned into two sets of functional units. For example, in a split architecture with only one central vector functional slice 410, a central vector multiplication tile that contains 16 ALUs can allocate the ALUs to either set. In other instances, additional vector functional slices 410 may be allocated to a set. The additional vector functional slices 410 may be physically or logically located, for example, next to one of the matrix functional slices 409.

For at least one implementation, FIG. 4 can depict the silicon layout of a LPU 401 with multiple Superlanes, as well as processor chip to processor chip (C2C) interface units 412 and the ICUs 414. In this example implementation, there are 20 Superlanes forming the majority of the floorplan of the laid-out silicon circuitry. Surrounding the Superlane partitions is circuitry for the ICUs, units for processor-to-processor communication, and units for host-to-processor communication. In one implementation, the host-to-processor units includes a PCIe (Peripheral Component Interconnect Express) circuit 413. In some instances, a host-to-processor communication unit can bidirectionally transfer data from the host computer through a permute/routing functional slice 411 to and from a memory functional slice 407. In some implementations, a processor-to-processor communication C2C unit 412 directly transfers data to a permute/routing functional slice 411.

One example implementation of a LPU 401 chip contains 26.8 billion transistors on a 725 mm² die built in 14 nm ASIC technology, and is designed using standard EDA tools from circuit design through tape-out before fabrication. The die area splits about evenly between memory and compute units (not counting I/O). Instruction control can involve only 3% of the die area. One Superlane in the example LPU 401 can be initially unused, so it can be connected to the rest of the architecture to replace any Superlane that is defective; this redundant feature adds only about 4% to the die area. In this implementation, each memory partition can have 44 memory functional slices 407 each including 20 memory functional tiles 302.

In some instances, a LPU 401 can include a large on-chip Static Random Access Memory (SRAM), which can in some instances reduce or eliminate a need for external memory. For this reason, a LPU 401 may not need to include DRAM controllers and interfaces. However, a processor device 201, 301, 401 can include a processor device configured to interact with external memory (e.g., external DRAM, etc.) without deviating from the scope of the present disclosure. Some example LPU 401 chips can include an ×16 PCI Express (PCIe) Gen4 interface to connect to a host processor (e.g., central processing unit of a host computing device, etc.). In some instances, compilers that execute on the host computer or another device can download the machine learning algorithm instructions and data to the LPU 401, such as from the host computer through the PCIe interface 413 through permute/routing functional units 211 (e.g., tiles, etc.) adjacent to the PCIe interface 413 into the memory functional slices 407 (e.g., MEM partitions including one or more memory functional slices 407, etc.). The LPU 401 can then autonomously execute the model by transferring the instructions and data in the MEM partitions into one or more functional slices 402. After processing, in some instances, results can be transferred from one or more functional slices 402 (e.g., vector functional slice(s) 410, etc.) back to the host computer (e.g., via one or more permute/routing slices 411 and via one or more PCIe devices 413.

Machine learning algorithms can in some instances operate on vectors with scalar coefficients of a specified data type (e.g., INT8, FP16, etc.). In some instances, Superlanes of a LPU 401 can operate on data representing vectors, sometimes organized into rank-2 tensors. In some instances, an LPU 401 can operate on higher-rank tensors by using a compiler to transform higher rank tensors into rank-2 tensors. In some instances, an LPU 401 can implement a programming model that is a producer-consumer model where each slice in a partition acts as a consumer and a producer of one or more streams.

In some instances, an LPU 401 architecture can support a plurality of streams (e.g., 32 streams, etc.) in each set of tiles in two directions. In some instances, a number of streams can be dependent on the availability of wiring of the inputs and outputs for the stream registers. In some instances, each stream can automatically progress in a designated direction (e.g., designated direction along a data flow axis 318 or data path 418, etc.) on every cycle (e.g., moving 32 bytes each cycle via 32 streams, etc.). In some instances, inter-lane data movement (e.g., data operand movement in a direction other than the data flow axis 318, etc.) within a vector can be performed using a permute/routing functional slice 411.

When a set of data representing a vector is read from main memory, it can be given a stream identifier (0.31) and direction of flow in a Superlane. Once a vector is read into one or more stream registers in a lane, it can become a stream and flow towards a functional slice 402 that is scheduled to process the vector, and the functional slice 402 can process the vector to produce a result stream. As data in a stream flows through a slice, each functional unit can intercept the data and perform a calculation (if the unit is calculational), or move data between lanes (e.g., in permute/routing functional slice(s) 411).

The stream registers can be used to transfer operands and results between slices. An example software pattern can include reading operand data from one or more memory functional slices 407 that is then subsequently consumed and operated on by a downstream arithmetic slice (e.g., matrix functional slice 409, vector functional slice 410, etc.). The results of the operation can then be transferred to another stream such that they can be written back to memory. For example, a Z=X+Y operation might be performed by executing four instructions: Read S1,X and Read S2,Y are executed on two memory functional slices 407 and directed toward a vector functional slice 410 to perform the Add S1,S2,S3. Then the result can be stored back to a memory functional slice 407 via a Write S3,Z.

An instruction can operate on data from different streams. For example, ADD S1, S2, S3 adds each value in stream 1 to the corresponding value in stream 2 and stores the results in stream 3.

In some instances, a functional slice 402 can include a functional unit 202 configured to perform a given operation (e.g., operation associated with a single instruction received from an instruction control unit 414, etc.) for a plurality of repetitions on operands streamed over a plurality of clock cycles. For example, in some instances, a functional slice 402 or component thereof (e.g., functional tile, etc.) can be configured to receive an instruction including repetition data indicative of a number of times to repeat a given operation; a number of clock cycles to delay between repetitions of the given operation; or other repetition data. Based on the instruction, the functional slice 402 can perform, at each of a plurality of clock cycles, the given operation on one or more operands arriving in one or more streams (e.g., Superlanes, etc.) at each of the plurality of clock cycles.

A lane structure configured to hold one byte per lane can be well suited for INT8 data, but larger operands (INT16, INT32, FP16, or FP32) can also be formed by combining streams. This approach can provide for a compiler to operate, for example, on 320-element vectors for all data types. Wider data types can be assigned to adjacent streams along aligned boundaries. For increased reliability, a Superlane can apply a 9-bit error-correction code (ECC) across all 16 lanes, correcting nearly all errors. AN LPU 401 can log these errors and report them to a host computer. In one implementation, the ECC protocol is SECDED (single-error correction with double error detection). Before a functional slice operates on a stream of data, it can check the ECC bits to ensure data integrity before operating on the data.

In some instances, each element of a stream can be 1-byte, with larger data types (e.g. INT16, INT32, and FP32) constructed from several streams (2, 4, and 4 respectively). Multi-byte data types can be handled such that they are always stream-aligned based on the size of the data type. For instance, INT16 can be aligned on a stream pair, bi-stream, and INT32 can be aligned on a quad-stream (e.g., one set of four adjacent data paths 318 per INT32 value, etc.). Data alignment can be accomplished by the compiler or through an application programming interface (API).

In some instances, each stream can have one or more “valid/empty” bits precisely tracking the stream's load-to-use time beyond which the stream is considered logically dead and no longer propagated, which can achieve a reduction in power consumption of the LPU 401.

Some instructions in the ICUs 414 can be common to all functional slices 402. As such, the instructions can contain common instructions like NOP and Repeat, and synchronization instructions Sync and Notify to provide the functional slices 402 to be initially synchronized, so a compiler can accurately determine instruction execution times and provide cooperative parallelism among the functional slices. ICUs 414 can retrieve pages of instructions in the MEM partitions, sending Ifetch instructions across side channels in the memory slices, and receiving the instructions from memory back along the same side channel.

The ICUs 414 can provide explicit instruction fetching for the slices with the Ifetch instruction, and inter-slice synchronization using the Sync and Notify instructions to perform a chip-wide barrier synchronization among participating functional slices. A repeated-NOP (no-op) instruction can provide for precise cycle-by-cycle control of inter-instruction delay. For example, a compiler can have cycle-accurate control when scheduling two operations A and B using an intervening NOP so that N clock cycles separate the operations A and B, i.e., Operation A then NOP(N) then Operation B.

A compiler can use explicit NOPs to provide temporal separation between two instructions in the program order. A NOP can have a repeat count 16-bit field which provides one NOP to wait between 1 ns and 65 s for a 1 GHz clock frequency. A compiler can use NOP instructions to control relative timing of the functional slices 402 and data on which the functional slices operate. A repeated NOP can be implemented in the ICU 414 and can be common to all functional slices 402. While a NOP instruction can be the most common instruction, the NOP instruction may not be included in the specification for a machine learning model, but rather may be inserted into the instructions generated from the model by a compiler.

In some instances, a vector functional slice 410 can include a central vector functional slice 410 containing 16 Arithmetic Logic Units (ALU) per lane. Each ALU can perform, for example, a 32-bit calculation using aligned groups of four stream bytes as operands. In addition to the usual arithmetic and logical operations of some conventional ALUs, ALUs of a vector functional slice 410 can be configured to convert between integer and floating-point formats. In some instances, a vector functional slice 410 can be configured to perform some predefined normalization functions such as ReLU and the hyperbolic tangent (tanh) as well as exponentiation and reciprocal square roots, providing programmers to build their own normalization functions.

In some instances, a language processing unit device 401 can be organized into a plurality of Superlanes, and a vector functional slice 410 can implement, for each Superlane, a 4×4 mesh of vector ALUs using the 16 vector ALUs per lane. In some instances, an ALU can be configured to receive 32-bit input operands, wherein each of an ALU's 32-bit input operands are organized along an aligned quad-stream group.

In some instances, a vector functional slice 410 ALUs can include stateless ALUs, such as ALUs that do not produce condition codes or status flags from the last instruction. For example, in some instances, instead of condition codes or status flags, a vector functional slice 410 can provide both saturating and modulo variants (add_sat, add_mod and mul_sat, mul_mod) for addition and multiplication, which can provide differing semantics for handling arithmetic exceptions. In some instances, a language processing unit 401 can support chaining together two or more vector ALUs within each lane, providing multiple ALU operations to be performed without transferring the intermediate results to main memory, saving a write and subsequent read of each intermediate result. This can in some instances provide for efficient parallel implementations of algorithms for batch normalization, quantization, or more complex activation functions like the leaky ReLU activation function, for example.

In some instances, a matrix functional slice 409 partition can include a plurality of independent regions (e.g., grids, etc.) of multiply-accumulate units, such as four independent 320-by-320 grids of multiply-accumulate (MACC) units. In some instances, each 320 by 320 grid can include 20 16 by 16 sub-grids that each produce a partial-sum/dot product result each cycle and pass the result to an adjacent functional tile 302 for use in its computations. In some instances, an N by N grid can use N streams each with N bytes to install N² parameters (e.g., 8-bit weights (IW), etc.) in each grid on every cycle. Using all 32 streams in each direction can provide weights to be placed simultaneously in multiple matrix functional slice 409 partitions, loading 409,600 weights (e.g., all weights of some example machine-learned models or model partitions, etc.) on-chip in less than 40 cycles. With weights installed, every cycle the matrix functional slice(s) 409 can generate a new dot-product (e.g., INT32 dot product, etc.) of input activations with installed weights. The features output from the matrix functional slice(s) 409 can be accumulated using accumulators on each INT32 or FP32 output stream.

In some instances, a matrix functional slice 409 can support calculations for multiple numerical formats by combining results from multiple lanes. For example, in some instances, a matrix functional slice 409 can support both 8-bit integer (INT8), and 16-bit floating point (FP16), by using two 320×320 byte-planes in tandem for the 16-bit floating point results. In some instances, a 320-element sum can be produced for each output with only a single rounding step at the end to convert to INT32 or FP32 results. Matrix functional slice 409 processing can include, for example, one or more of the following operations (instructions): LW—load weights from data flows (streams) to weight buffer; IW—install weights from data flows (streams) or LW buffer into the 320×320 array; ABC—activation buffer control to initiate and coordinate arriving activations; ACC—accumulate either INT32 or FP32 result from MXM.

In some instances, each MACC unit can have two 8-bit weight registers and two 32-bit accumulators. On each cycle, each MACC unit can multiply the stored weight values by a pair of activation values from the streaming data. In some instances, each 16×16 sub-grid can compute an integer partial sum in one cycle and a complete 320-element fused dot-product in 20 cycles. In some instances, a MACC unit can instead operate as a single FP16 MACC, but these operations can require two cycles, reducing throughput by 75% relative to INT8 operations. In some instances, each matrix functional slice 409 partition can have 320×320 MACC units producing 409,600 INT8 operations or 102,400 FP16 operations per cycle. Using all 32 streams in each direction, the LPU can load all 409,600 weight registers in less than 40 cycles.

The permute/routing functional slice(s) 411 (sometimes referred to herein as switch units, ‘SXM’ or ‘NET’) can execute functions for the transposition, permutation, shifting and rotation of data elements. Collectively, these operations can be used for performing tensor reshape operations, such as tensor reshape operations associated with one or more machine learning operations. For example, in some instances, a permute/routing functional slice 411 can rotate or transpose a stream of data across the lanes. In some instances, a permute/routing functional slice 411 can duplicate bytes to fill a vector or zero any of the vector elements to pad values. In some instances, permute/routing functional slice 411 can be the only tiles of a processor device 401 that communicate between Superlanes. Further details of some example permute/routing functional slices 411 are disclosed in U.S. Pat. No. 10,754,621, incorporated herein by reference.

Data movement on-chip can be carried out by routing data along one or more pathways, such as pathway(s) where data is transferred between SRAM and functional units within each Superlane, and pathway(s) where the permute/routing functional slice 411 transfers data across lanes using two sets of lane shifters. The lane-shifters can in some instances be allocated in pairs to facilitate shifting a vector between a lane and its two adjacent lanes in a Superlane. Additionally, in some instances, the permute/routing functional slice 411 can provide a permute instruction that uses a programmed bijection to remap a plurality of lanes (e.g., 320 lanes, etc.) onto a set of similarly indexed streams, one per Superlane.

In some instances, permute/routing functional slice 411 can include one or more distributor slices. For example, a distributor slice within a permute/routing functional slice 411 can be used to arbitrarily remap a plurality of (e.g., 16) lanes within each Superlane. As streams pass through the SXM's distributor, they can be remapped at full bandwidth, or zero-fill any or all of the 16 elements. This can provide an efficient mechanism for common tensor operations like zero padding or rearranging elements of a convolutional neural network filter (e.g., 4×4 filter, etc.).

An example operation on tensor data types can include transposition. In some instances, an LPU 401 can support a two-dimensional transpose of 256 elements organized as 16 streams each with 16 elements. A transpose operation can take 16 incoming streams and produce 16 output streams with the rows and columns exchanged. This provides the efficient movement of data from the atomic 16-byte MEM word into 16 different MEM slices where they are now addressable. In some instances, an LPU 401 can include two instances of the SXM on-chip, one in each hemisphere. Each can issue, for example, two (2) transpose instructions, yielding a maximum of four (4) simultaneous transpose 16×16 operations.

In some instances, a tensor streaming processing device 401 can have a plurality of memory partitions (e.g., two partitions, etc.) each having 44 memory functional slices 407 including ECC-protected SRAM, with each slice including 20 tiles that provide a total capacity of 2.5 MiBytes (wherein a Mibyte is 1048576 bytes) per slice, giving the two MEM partitions a total capacity of 220 MiBytes. Each memory functional slice 407 can include, for example, at least two sets of memory cells referred to as ‘banks’. Each MEM slice can include pseudo-dual-port SRAMs that can service a pair of read and write requests simultaneously, assuming they are not targeting the same bank. In such instances, the 88 memory functional slices 407, each with 2 banks, can provide up to 176-way memory concurrency to read operands to or store results from streams. Banks of memory not being used can have their power reduced to reduce energy usage.

In some instances, the memory functional slices 407 can be configured to provide sufficient memory concurrency to supply a target number (e.g., 32, etc.) of operands per lane, every cycle. For example, in some instances 88 slices having 176-way memory concurrency can provide sufficient concurrency to supply 32 operands per lane each cycle. In some instances, memory functional slices 407 can be partitioned into 16-word bytes, each word distributed across a Superlane, and each byte of each word processed by one lane of the Superlane. In some instances, a memory functional slice 407 can perform two 16-byte reads and two 16-byte writes per cycle, as long as they access different banks, providing it to both source and sink data in two directions across all lanes in a Superlane.

In some instances, on-chip memory can supply operands for each functional slice 402 by reading an address from a memory (MEM) functional slice 407, denoted MEM. In some implementations, slices in each memory can be numbered 0 to 43, with MEM₀ closest to the vector functional slice 409 and MEM₄₃ nearest to the permute/routing functional slice 411.

In some instances, memory partitions can provide the programming abstraction of a partitioned global shared address space with the address space laid out uniformly across the slices. In some instances, each memory functional slice 407 can support both direct and stream-indirect addressing modes. Read and Write operations can use direct addressing, since the address is fully specified in the instruction itself. Indirect addressing can use the contents of a stream, s, to specify an address map for a Gather or Scatter. With indirect addressing, the physical address can be transmitted within the stream value, providing a layer of indirection in the memory referencing.

In some instances, each memory functional slice 407 can have two dedicated dispatch paths, one for each port of the pseudo-dual-ported SRAM. Each memory instruction can undergo an additional address generation stage for strided references by computing the address a, from the previous address aᵢ₋₁ and strides so that aᵢ=aᵢ₋₁+s between locations. Strided memory references can be accomplished using a sequence of countdown, step, and iters MEM instructions.

This iteration mechanism in the address generation circuitry can support for example, multiple levels (e.g., up to four-levels, etc.) of nested iteration providing for multi-dimensional arrays to efficiently encode tensors as a short sequence of read or write, or gather or scatter, operations followed by countdown, step, and iter instructions to control the loop bounds. The countdown instruction can specify an inter-loop delay in cycles.

As a non-limiting illustrative example, consider an LPU 401 having a 1 GHz operating frequency of the LPU 401 clock. The stream register bandwidth, B, exported by each MEM interface on the East and West edge of each MEM partition can keep the functional units adequately fed with data operands in order to saturate the peak arithmetic capacity of the functional units. The stream registers can provide a combined capacity of 20 TiB/s of read (operand) and write (result) bandwidth (a Tib is a Mibyte of Mibytes).

To maximize stream concurrency, a compiler can allocate memory for concurrent stream operands associated with a single tensor into separate memory functional slices 407. For example, as the streams propagate through the MEM system they can “pick up” the arguments from a plurality of separate memory functional slices 407 enroute to one or more other functional slices 402 (e.g., matrix functional slices 409, etc.). In some instances, a compiler can explicitly schedule individual banks of each MEM slice to achieve fine-grain memory management. This can provide design patterns and use-cases where simultaneous reading of operands from one bank and writing of results to the other bank in the same memory functional slice 407. As an example, a transpose instruction can take 16 input streams and produce 16 output streams with the rows and columns transposed. By using the bank concurrency available within each memory functional slice 407, it is possible to use the pseudodual-ported SRAM for dual read/write accesses per memory functional slice 407.

In some instances, an LPU 401 can include a memory system that is unlike a memory system of a conventional central processing unit (CPU). For example, some conventional CPUs may rely on a memory hierarchy to implicitly move data between caches to service load/store operations. Cache hierarchies can introduce a reactive agent in the data path and can introduce undesired unpredictability, or non-determinism, in the data path to provide the illusion of sequentially consistent memory transactions within the memory hierarchy.

In some instances, an LPU 401 can differ from a conventional CPU memory by providing a memory management layer that identifies the memory concurrency on an operation by operation basis. In some instances, the memory functional slices 407 can store very long instruction word (VLIW)-like instructions, such as instructions that are 2,304 (144×16) bytes wide. In some instances, a program can fetch instructions when the memory functional slices 407 are otherwise idle. For example, in some implementations, instruction fetches can require less than 10% of the total memory bandwidth of the memory functional slices 407. Instructions can be decoded and loaded into queues, providing the program to prefetch. To reduce code size, a REPEAT N instruction can repeat a previous instruction N times. In some instances, a program can specify a NOP instruction to last for N cycles.

Each functional slice 402 can have a predefined set of instructions (e.g., Read, Write, Add, Mul, etc.) that define its supported operations. Furthermore, functional slices 402 can consume operands from, and produce results to, streams. A more complex sequence of operations, a microprogram, can be composed of one or more slices 402 coordinating in a producer-consumer manner to create one or more output streams. This can be accomplished by logically chaining multiple slices 402 together to consume input data from up-stream slices 402, operate on that data to produce a new result stream, where it later can be consumed by a down-stream slice 402 in a similar manner. In some instances, each functional slice 402 can choose a direction of its result stream. With this cooperative producer-consumer model operating on data streams, more elaborate operations can chain together different functional slices 402, for example, where a composite function, F (x, y, z)=MEM(x)→SXM(y)→MXM(z), is an amalgam of several functional slices 402 chained together.

This dataflow composition exploits ‘data flow locality’ by passing the same data across multiple functional slices 402 which can operate on the data to produce some output stream. The output from one functional slice 402 can be transferred to the input of another slice 402 providing for chaining of operations through a common stream register.

In some instances, the underlying data type supported by an LPU 401 can be a vector. For example, in some instances, number of elements in each vector can vary from 16 elements, one Superlane, all the way to 320 elements using all 20 Superlanes on-chip. That is, the minimum vector length, or minVL, can be 16 bytes and the maximum vector length, or maxVL can be a 320 byte-sized element array. Because the vector length can vary from 16 to 320 elements, instructions can configure each tile for a low-power mode to effectively power down any unused Superlane (row of the mesh) and reduce the power consumed. This scalable vector approach provides the vector length to grow from 16 to 320 bytes in 16-lane steps, powering-down the unused tiles, yielding a more energy-proportional system.

In some instances, an instruction set architecture of an LPU 401 can provide temporal information about each instruction to provide a compiler precise control of each instruction's dispatch time. For example, in some instances, each instruction can be augmented with one or more of the following temporal parameters:

dfunc functional delay—each instruction requires 1 or more cycles to produce its stream output. A functional delay timing parameter can provide the compiler to reason about when the output of an instruction will be available on the architecturally-visible stream registers.

dskew instruction-operand skew—the timing relationship between the instruction dispatch time relative to when its stream operands are required. An instruction-operand skew parameter on each instruction can inform a compiler how to schedule the operand arrival times with the instruction dispatch time in order to get them to properly intersect in time and space.

Such parameters can be useful to track the exact spatial relationship between instructions and operands.

In some instances, a programming model for an LPU 401 can include, for example, the following two elements: (1) scheduling specific data paths in hardware, and (2) exposing temporal information about an instruction's execution latency through the Instruction Set Architecture (ISA), so that the compiler's back-end can precisely track the position and time-of-use of any stream on-chip.

A compiler can use NOP instructions to control the relative timing of the functional slices 402 and the data on which they operate. A NOP can have, for example, a repeat count 16-bit field which provides one NOP to wait from Ins up to 65 s for a 1 GHz clock. The NOP instruction can be implemented in the ICU's tile and can be common to all functional slices. The NOP can provide the slice to turn off the clock when performing no operations for anything longer than a few cycles (i.e., n>4 cycles).

Each functional slice 402 can be independent; however, the compiler can keep track of a logical program time. Conceptually this can be similar to a program counter in a conventional CPU, except the compiler can track the state of a plurality of (e.g., 144, etc.) independent program queues on a cycle-by-cycle basis. So, at logical time t the compiler can know the state of each Instruction Queue (IQ) inside each Instruction Control Unit. NOP instructions coordinate the temporal relationship between instructions in the same IQ, or between instructions in different IQs. In addition to repeated-NOPs, a higher-level synchronization across all functional slices 402 on a chip can be provided in order to reason about program correctness. For example, in some instances, Sync and Notify instructions can provide a barrier synchronization mechanism across all independent queues on the LPU 401. One IQ can be designated as a notifier configured to issue a Notify instruction while all other IQs can be parked on a Sync instruction. The receipt of a Notify can be broadcast to all the IQs to satisfy the pending Sync and begin processing instructions again.

This barrier synchronization can be performed, for example, only once after the LPU 401 resets. However, in practice, some programs may start with a set of “preamble” instructions which configure each tile. After that a Sync instruction can be performed to ensure that all functional slices are aligned to the same logical time. In some example implementations, a chip-wide barrier synchronization can be accomplished in 35 clock cycles, from the time a Notify is issued to the time a Sync is satisfied and retired to provide subsequent instructions to flow. After this barrier synchronization, the functional slices 402 can compute and communicate results in a synchronization-free manner through the stream registers.

Repeat (n, d) is an ICU instruction issued to repeat a previous instruction n times, with d cycles between each iteration. Providing variable amounts of delay between iterations can provide a compiler to temporally align the repeated instruction with its operands in-flight. This simple but flexible iteration mechanism can provide vector functional slices 410 and matrix functional slices 409, which are often highly iterative, to encode their instructions more efficiently by making better use of main memory and reducing the number of Ifetch instructions compared to if the loop were unrolled.

An Ifetch instruction can have a single stream operand which carries the instructions in their program order, filling an instruction queue with, for example, 640-bytes (e.g., a pair of 320-byte vectors) of instructions. In some instances, all functional slices 402 can fetch instructions simultaneously with normal instruction execution. In some instances, a compiler can perform omniscient prefetching of the program's instructions to keep all 144 IQs busy on each cycle by inserting Ifetch instructions into every slices' instruction stream. In some instances, an LPU 401 or compiler can include a mechanism to ensure that IQs never are empty so that a precise notion of ‘logical time’ is maintained across the processor.

In some instances, an LPU 401 can be configured to transmit data along a stream without packet routing, arbitration, or the like. For example, on each tick of the core clock, the LPU 401 can propagate stream values by one stream register hop. The LPU 401 hardware can, for example, propagate stream values without tracking the origin or destination slice, such as by providing streams to simply propagate until they fall off the edge of the chip or are overwritten by a functional slice 402. In some instances, an LPU 401 can use stream registers within each memory functional slice 407 to move data along a Superlane, and can use one or more permute/routing functional slices 411 to move data between Superlanes. An instruction can specify one or more source streams-direction pairs, and a target stream and output direction for the result, effectively providing direction routing of the stream data.

In some instances, a network of LPU 401 processors can be connected via Chip-to-Chip (C2C) units 412. The processors 401 can logically behave as if all chips share a common clock and are connected via time multiplexed wires. LPU 401 chips connected via C2C 412 do not need to share a clock; reasonable alignment of the frequency of the clocks (measured in PPM) can suffice. In some instances, receive buffers in the communications units can be large enough so that the expected PPMs of clocks don't require a realignment more than once per millisecond, or otherwise don't require realignment often enough to cause difficulty in scheduling between model executions.

In some instances, C2C units 412 can either provide sufficient Forward Error Correction for data transfer between chips such that unrecoverable errors will occur<1 per week per chip when using all C2C links, or provide software with a mechanism to add additional redundancy so that errors will occur<1 per week per chip when using all C2C links 412. If error rates are lower at a lower transfer rate (e.g. 16 Gb/s), then SerDes can be configured to run at a lower rate for improved precision.

Transfers of data between LPU chips 401 during a compute phase of a program can be supported, e.g. while COMPUTE[i].CHIP[A] is running on chip A, it may send data to COMPUTE[i].CHIP[B] on chip B, which may result in data being returned to COMPUTE[i].CHIP[B] and used before the computation completes. This can differ, for example, from some from PCIe 413 implementations, which may only provide data to be transferred before and after a COMPUTE phase.

In some instances, each C2C 412 SerDes of an LPU 401 can be an independent link, e.g., each link may be the only connection to another device or may be one of multiple connections to another device. Multi-chip systems can be implemented in a variety of topologies for flexible packaging and deployment in rack-scale and cluster scale systems. Communication can occur in a pair-wise manner between a sender port and a receiver port. A sender can perform a MEM read to read an address a onto a stream heading toward a permute/routing functional slice 411. The permute/routing functional slice 411 can perform a Send on the C2C unit 412 representing the physical port where the data is transmitted. On the other side of the link, after a fixed delay for time-of-flight on the wire, the LPU 401 performing the Receive instruction can pull, for example, a 320-byte vector off the channel for every Receive issued.

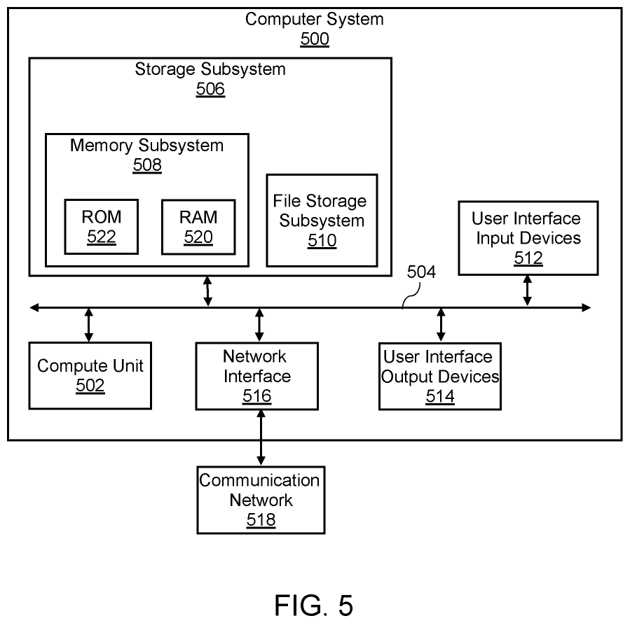

FIG. 5 depicts a block diagram of an example computer system 500 according to example aspects of the present disclosure. The structure of the computer system 500 can include at least one compute unit 502. The at least one compute unit 502 can communicate with peripheral devices via bus subsystem 504. The compute unit 502 can include a processor (e.g., a microprocessor, graphics processing unit, AI co-processor or digital signal processor), or its electronic processing equivalents, such as an Application Specific Integrated Circuit (‘ASIC’) or Field Programmable Gate Array (‘FPGA’). Peripheral devices may include a storage subsystem 506, including a memory subsystem 508 and a file storage subsystem 510, user interface input devices 512, user interface output devices 514, and/or a network interface subsystem 516. The input and output devices provide for direct and remote user interaction with computer system 500. The computer system 500 provides significant post-process activity using at least one output device and/or the network interface subsystem.

The computer system 500 can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that performs processes for, and sends data and information to, another computer or processor.

A computer system 500 can be structured, in part, with at least one operating system program. The computer system 500 can include a Basic Input/Output System (BIOS) and processor firmware. The operating system, BIOS and firmware are used by the processor to structure and control any subsystems and interfaces connected to the processor.

Any implementation of the subject disclosure is limited neither to an electronic digital logic computer structured with programs nor to an electronically programmable device. For example, the various implementations can use an optical computer, a quantum computer, an analog computer, or the like. In other implementations, a computing machine such as a language processing unit can be utilized. Further, where only a single computer system or a single machine is signified, the use of a singular form of such terms also can signify any structure of computer systems or machines that individually or jointly use processes. Due to the ever-changing nature of computers and networks, the description of computer system 500 depicted in FIG. 5 is intended only as an example.

Network interface subsystem 516 provides an interface to outside networks, including an interface to communication network 518, and is coupled via the communication network 518 to corresponding interface devices in other computer systems or machines. Communication network 518 can include many interconnected computer systems, machines, and physical communication connections (signified by ‘channels’). These communication channels can be wireline channels, optical channels, wireless channels (e.g., using the Wi-Fi or Bluetooth protocols), or any other physical devices for communication of information. Communication network 518 can be any suitable computer network, for example a wide area network such as the Internet, and/or a local- to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Implementations of communications interfaces can include an Ethernet card, a modem (e.g., telephone, satellite, cable, or Integrated Services Digital Network (ISDN)), (asynchronous) digital subscriber line (DSL) unit, Firewire interface, universal serial bus (USB) interface, and the like. Communication algorithms (‘protocols’) can be specified using one or more communication languages, such as Hypertext Transfer Protocol (HTTP), Transmission Control Protocol/Internet Protocol (TCP/IP), Real-time Transport Protocol/Real Time Streaming Protocol (RTP/RTSP), Internetwork Packet Exchange (IPX) protocol and/or User Datagram Protocol (UDP).

User interface input devices 512 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. As used herein, the term ‘input device’ signifies all possible types of devices and processes to transfer data and information into computer system 500 or onto communication network 518. User interface input devices provide for a user to select objects, icons, text and the like that appear on some types of user interface output devices, for example, a display subsystem.

User interface output devices 514 can include a display subsystem, a printer, a fax machine, or a non-visual communication device such as audio and haptic devices. The display subsystem can include a cathode ray tube (CRT), a flat-panel device such as a liquid crystal display (LCD), an image projection device, or some other device for creating visible stimuli such as a virtual reality system. The display subsystem can also provide non-visual stimuli such as via audio output, aroma generation, or tactile/haptic output (e.g., vibrations and forces) devices. As used herein, the term ‘output device’ refers to any of a number of possible types of devices and processes to transfer data and information out of computer system 500 to the user or to another machine or computer system.

Such devices are connected by wire or wirelessly to a computer system. Note that some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits that use any of the above input or output devices.

Memory subsystem 508 may include several memories, such as a main random-access memory (‘RAM’) 520 (or other volatile storage device) for storage of instructions and data during program execution and a read only memory (‘ROM’) 522 in which fixed instructions are stored. File storage subsystem 510 provides persistent storage for program and data files, and can include a hard disk drive, a floppy disk drive along with associated removable media, a CD-ROM drive, an optical drive, a flash memory such as a USB drive, or removable media cartridges. If computer system 500 includes an input device that performs optical character recognition, then text and symbols printed on a physical object (such as paper) can be used as a device for storage of program and data files. The databases and units used by some implementations can be stored by file storage subsystem 510.

Bus subsystem 504 provides a device for transmitting data and information between the various components and subsystems of computer system 500. Although bus subsystem 504 is depicted as a single bus, alternative implementations of the bus subsystem can use multiple buses. For example, a main memory using RAM can communicate directly with file storage systems using DMA systems.

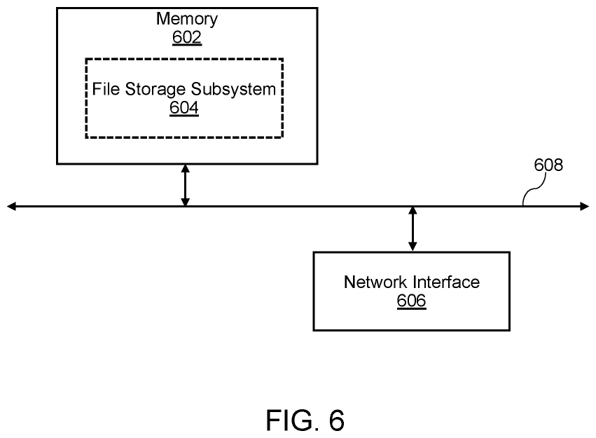

FIG. 6 depicts a memory 602 such as a non-transitory, processor readable data and information storage medium associated with file storage subsystem 604 (e.g., file storage subsystem 506), and/or with network interface subsystem 606 (e.g., network interface subsystem 516) and can include a data structure specifying a circuit design. The components of FIG. 6 can be communicatively coupled via a bus 608.

The memory 602 can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program or data transferred into and out of a processor from a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light).

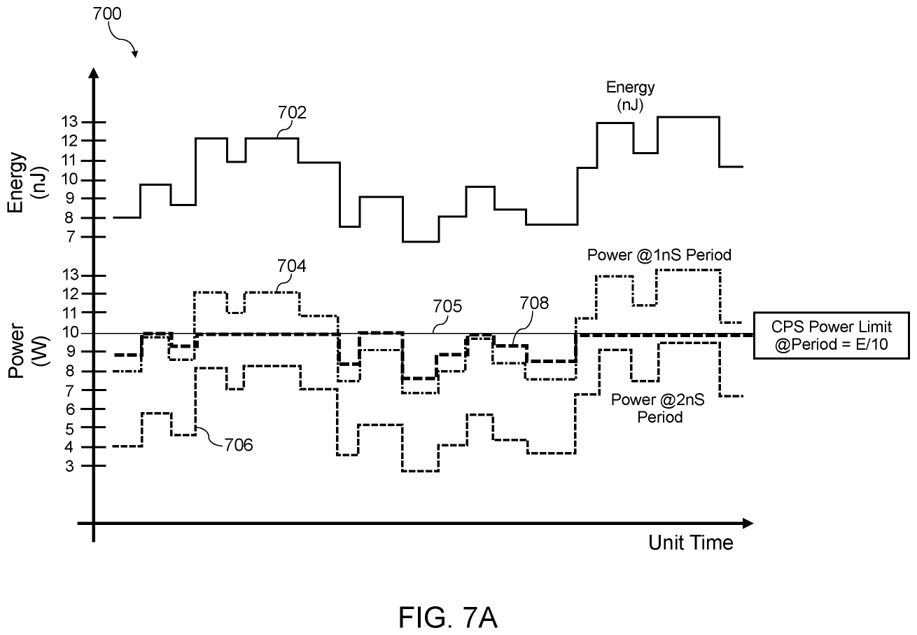

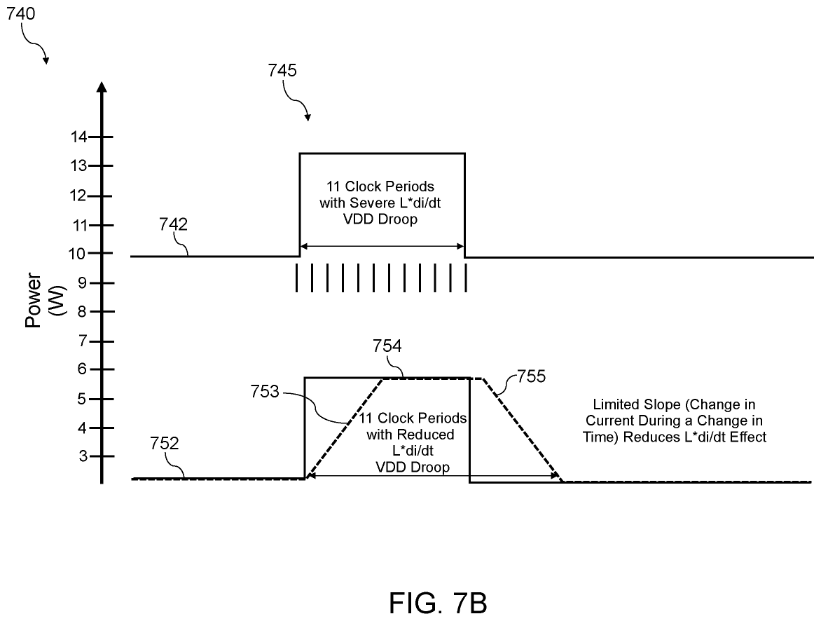

FIGS. 7A-7B depict exemplary clock waveforms and power usage by the processor driven by the waveforms according to example aspects of the present disclosure. The below discussion with respect to FIGS. 7A-7B is provided for the purpose of illustrating some aspects of the present disclosure. Limitations described in the implementation of FIGS. 7A-7B are not necessarily envisioned as present in all implementations of the present disclosure, but rather are discussed for the purpose of illustrating principles that are believed to relate to the present disclosure.

Power consumption as it relates to a clock waveform of a processor can be proportional to the capacitance (C) of processor switches (e.g., each of the processor switches) multiplied by the square of the processors main voltage supply (V_{dd}) divided by the period (P) of the clock waveform, mathematically represented by

$$C \frac{{V}_{d d}^{2}}{P} .$$

A processor, for example, using a 1 nanosecond clock period can consume about or exactly twice as much power as a processor using a 2 nanosecond clock period, albeit performing the algorithm roughly half as fast. It should be readily apparent that the capacitance component can have a detrimental effect on power consumption if unnecessarily high.

In some implementations, the processor can include the following elements: a High Frequency Clock (HFC) generated on an on-chip Phase Locked Loop (PLL) circuit, where the period of the HFC can be shorter than the nominal period of the main clock (ChipClock) period; a waveform generator to produce ChipClock waveforms described herein; a duration logic block to preload values for the waveform generator; and/or an instruction control unit (ICU) to provide instructions for the CPS methods disclosed herein. The ICU can be, for example, the ICU described in FIGS. 1-6.

ChipClock waveform resolution can, in some implementations, be half of the HFC period. For instance, this can represent a smallest increment of change for the ChipClock period. The duration of half of the HFC period can be referred to as the High Frequency Clock Phase Period (HFCPP).

As an example, an HFC period that is one-eighth the nominal ChipClock period can provide an HFCPP that is 1/16th of the nominal ChipClock period. This HFCPP can be said to provide a clock period waveform resolution granularity of plus-or-minus 6.25%.

The nominal ChipClock period can be an integer multiple of the HFCPP. The multiple can be, but is not necessarily, a power of two. A chip reset signal can be used to set the ChipClock period to the Default ChipClock duration. The default ChipClock period can be overwritten by a CSR write. The CSR can also include a MinClockPeriod field. The MinClockPeriod field can specify a minimum number of HFCPP periods for a ChipClock. Additionally and/or alternatively, the CSR can include an EnableClockChange flag. When the EnableClockChange flag is toggled active, the CSR can prohibit any ChipClock period changes. The default value of the MinClockPeriod minimum ChipClock period register can be equal to the hardware value of the DefaultChipClock period, in some implementations. In some cases, the DefaultChipClock period can be equal to or greater than the MinClockPeriod. In some implementations, a default value of the EnableClockChange flag is FALSE. This can provide for prohibiting clock period changes until a CSR register write operation sets the value of the flag to TRUE. For example, after the processor has booted (e.g., or restarted) and a program is running, if the EnableClockChange flag is set to TRUE, ChipClock period changes can be determined exclusively by subsequent software instructions, and a CSR write is therefore not used to change the period until after the user instructions have completed.

In some implementations, the minimum ChipClock period can be four times the HFCPP. Additionally and/or alternatively, in some implementations, the minimum ChipClock high time can be twice the HFCPP. Additionally and/or alternatively, the minimum low time can be twice the HFCPP. Implementations where the minimum ChipClock high time and low time are equivalent can provide for forming a waveform with a 50/50 duty cycle. In some implementations, the HFC frequency can be at least twice the frequency of the fastest ChipClock frequency that will be used.

Thus, in some implementations, the longest possible ChipClock period can be limited by either the maximum size of the Target ChipClock Period field in the instruction format (e.g., 3+2\hat{ }11=2,051) or by the number of shift register stages implemented in the CCU (Chip Control Unit). The instruction format and CCU shift register properties are described in respective sections below.

In some implementations, processor current flow changes (di/dt) can be managed by setting the Slope, Steep, and Linear fields in a CPS instruction word to values that increase or decrease the rate of change of the current drawn by the processor per unit time. This capability can be used to control the rate of change in load current imposed on the voltage regulator during large step increases in load current, or during large release reductions in load current (when fewer instructions are being executed).

As one example, in one particular implementation described below, the Slope, Steep, and Linear fields can be binary fields having a value of either 0 (e.g., FALSE) or 1 (e.g., TRUE) For example, if Linear=0 and Steep=0, the ChipClock period can be increased or decreased by another unit of HFCPP after each Slope ChipClock periods have been completed (e.g., until the ChipClock period equals the TargetPeriod.) A larger Slope value can instead cause the di/dt value to be smaller. As another example, if Linear=0 and Steep=1, the ChipClock period can be increased or decreased by Slope units of HFCPP after each ChipClock period has been completed (e.g., until the ChipClock period equals the TargetPeriod.) A larger Slope value can cause the di/dt value to be larger. As another example, if Linear=1 and Steep=0, the ChipClock period can be increased or decreased by another unit of HFCPP after each time (Slope+Extra) ChipClock periods have been completed (e.g., until the ChipClock period equals the TargetPeriod.) The number of Extra ChipClock periods can be determined by the duration logic block based on the number of HFCPP periods in the current ChipClock period. For example, if the ChipClock period is a small number of HFCPP periods, Extra ChipClock periods can be added between changes in the value of the ChipClock period to linearize the di/dt with respect to the duration of the ChipClock period. As another example, if Linear=1 and Steep=1, the ChipClock period can be increased or decreased by (Slope−Extra) units of HFCPP after each ChipClock period has been completed (e.g., until the ChipClock period equals the TargetPeriod.) The number of Extra HFCPP units to be subtracted can be determined by the duration logic block based on the number of HFCPP periods in the current ChipClock period. In some implementations, if the ChipClock period is a small number of HFCPP periods, Extra HFCPP units can be subtracted between changes in the value of the ChipClock period to linearize the di/dt with respect to the duration of the ChipClock period.

With adequate timing information describing different timing support for different subsets of instructions, the compiler can identify certain instruction subsets or segments of instructions that may operate at a shorter clock period than other instruction subsets or segments. As used herein, both subsets and segments refer to a sequence of instructions. A program may include many such instruction subsets or segments of instructions.

Consider, for example, an example deterministic processor having 144 separate Instruction Control Units (e.g., each independently serving a functional slice). Consider also that data pathways that are not being used can have clock gating applied. After profiling the instruction mix emitted by the compiler, a commonly occurring subset or segments of instructions can be identified that are not in the blocks with the most difficult critical paths. An operational mode can be configured to run STA, where for example no vector-matrix multiply (VXM) instruction is dispatched, and no memory write operations are underway. If timing is closed with a shorter clock period in this mode, then CPS can use a shorter clock period whenever no instructions are underway outside of this subset.

Turning now to FIGS. 7A-7B, these figures illustrate the challenges of power management in high-performance processors and the benefits provided by the systems and methods described herein.

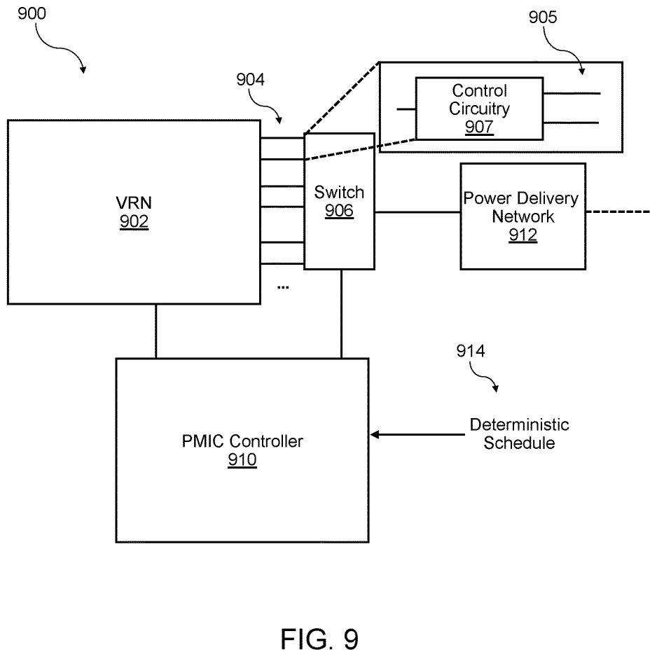

More particularly, FIG. 7A illustrates a chart 700 showing the relationship between energy per operation, power consumption, and clock period. A first trace 702 represents the energy (in nanojoules, nJ) utilized for a sequence of operations over time. The lower traces represent the corresponding power consumption (in Watts, W) under different clocking schemes. CPS power limit 705 illustrates a theoretical limit on power that should be provided to a processor for executing a sequence of operations. A second trace 704 illustrates the power consumption if the processor operates at a fixed, fast clock period (e.g., 1 ns). This results in high peak power, which can stress the power delivery system (e.g., at portions extending beyond the CPS power limit 705). A third trace 706 illustrates the power consumption at a fixed, slow clock period (e.g., 2 ns), which results in lower peak power but also lower performance. For instance, while the third trace 706 does not exceed the CPS power limit 705, there are a number of portions where power is underutilized relative to a safe system capacity, and the slower (e.g., 2 ns) period could theoretically be increased for faster processing without exceeding the power capacity of the system. A fourth trace 708 represents an idealized power limit achievable with cycle-by-cycle period scaling (CPS), where the clock period is dynamically adjusted to keep power consumption below the CPS power limit 705 while maximizing performance. For instance, the period can be specified at each “tick” to maintain the total power usage at or below the CPS power limit 705 for each cycle, where the period is decreased for more power-intensive ticks and increased at less power-intensive ticks. The systems described in the present disclosure, such as the system of FIG. 9, provide for the processor to closely follow such an ideal power curve by providing rapid voltage adjustments needed for dynamic clock period changes.

FIG. 7B illustrates a chart 740 comparing the effect of a sudden increase in load current on the processor's supply voltage (V_{dd}) in a conventional system versus a system implementing aspects of the present disclosure. A first trace 742 represents the power drawn by a processor during a rapid transition from a low-power state to a high-power state at 745, such as when initiating a complex computation. In a conventional system, this sudden change in current (di/dt) can interact with the inductance (L) of the power delivery network, causing a severe voltage droop at the state transition 745, which can lead to timing errors or system instability. A second trace 752 illustrates the controlled power ramp-up provided by the present disclosure. By using the deterministic schedule to anticipate the increased load, the PMIC controller can manage the VRN and/or clock period to create a more gradual increase in current, as shown by the limited slope of the power ramp from an increasing portion 753 to a stable portion 754. This controlled ramp reduces the L*di/dt effect, mitigating or eliminating the voltage droop and maintaining a stable V_{dd} during the stable portion 754. Subsequently, the PMIC controller can decrease the provisioned power during decreasing portion 755 according to this limited slope, reducing the occurrence of current surges.

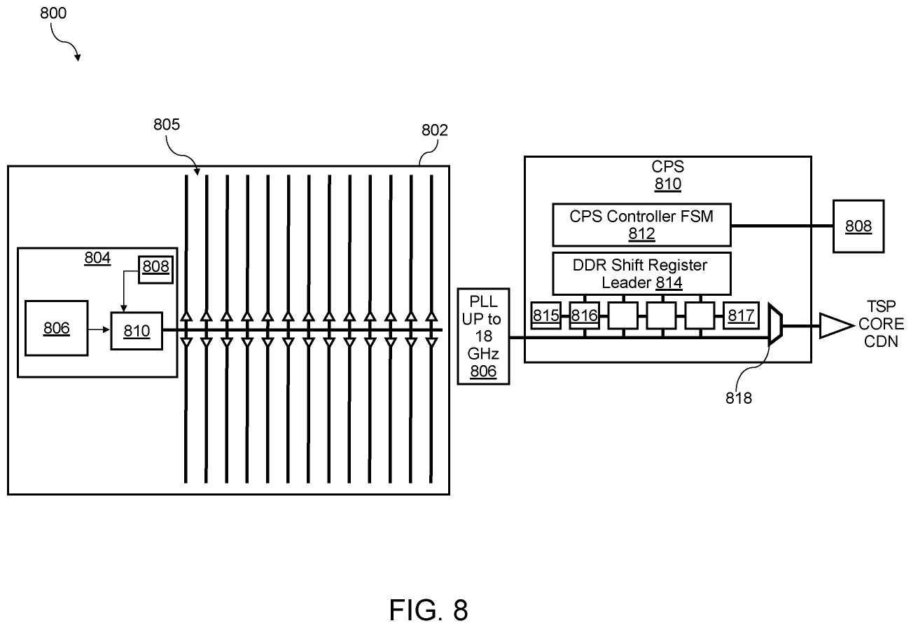

A relatively small number of logic gates can be used to implement CPS. For instance, FIG. 8 depicts an example CPS system illustrating how CPS may be implemented with a relatively small number of toggle flip-flops.

More particularly, FIG. 8 illustrates a diagram of an example cycle-by-cycle period scaling (CPS) circuit 800 according to example aspects of the present disclosure. The CPS system 800 provides a mechanism for implementing the dynamic clock frequency changes that are supported by the rapid voltage switching of the present disclosure. The CPS system 800 is implemented within a portion of a processor 802, such as a language processing unit. A Chip Control Unit (CCU) 804 includes and/or is coupled to a Phase-Locked Loop (PLL) 806, an Instruction Control Unit 808, and/or a CPS circuit 810. A high-frequency clock, such as an 18 GHz clock, is generated by the PLL 806. This clock serves as a time base for the CPS logic. The ICU 808 provides instructions to the CPS circuit 810, which contains circuitry implementing some or all of the CPS logic.

An expanded view of the CPS circuit 810 is illustrated on the right side of the diagram of FIG. 8. The CPS circuit 810 includes a CPS controller 812, which can be a finite state machine (FSM). The CPS controller 812 receives instructions and manages the generation of the final chip clock. The CPS controller 812 can include or act as a Ramp Counter/Linearizer that is responsible for managing the rate of change of the clock period, ensuring smooth transitions between frequencies to mitigate large current spikes (di/dt), as previously discussed with reference to FIG. 7B.

A DDR Shift Register Loader 814 loads duration values into programmable delay lines, implemented here as shift registers 816. These shift registers 816 are clocked by the high-frequency clock from the PLL 806. The duration of the high and low phases of the output chip clock is determined by the number of high-frequency clock cycles counted by these shift registers. By preloading new duration values into the registers, the CPS system 800 can change the chip clock's period on a cycle-by-cycle basis, enabling the fine-grained power management described herein. The output of this circuit is a variable-period clock that is delivered to the core of the LPU at 805.

For instance, the FSM 812 provides commands to the DDR Shift Register Loader 814. The loader 814 translates the desired clock period and ramp profile from the FSM into specific integer values. These values represent the number of high-frequency clock cycles from the PLL 806 that will constitute the high and low phases of the next chip clock cycle.

These calculated duration values are then loaded into a bank of shift registers 816, which function as a programmable digital delay line. The shift registers are continuously clocked by the high-frequency PLL. A signal propagating through a portion of the register bank is delayed by a precise number of high-frequency clock cycles, as determined by the value loaded from the loader 814. A DFT RST (Design-for-Test Reset) block 815 provides a reset signal to the shift registers 816, providing them to be placed in a known state for testing and debug purposes.

After the programmed delay has elapsed, a signal from the shift registers 816 triggers a toggle component 817. The toggle component 817, which can be implemented as a T-flip-flop, changes its output state (e.g., from high to low, or low to high) upon each trigger. The successive toggling of this component's output generates the final variable-period chip clock waveform, where the time between edges is precisely controlled by the CPS logic.

Finally, a Bypass Multiplexer (MUX) 818 selects the clock signal that is ultimately delivered to the TSP Core 805. One input to the multiplexer is the dynamically generated clock from the toggle component 817. Another input (not explicitly shown) would be a fixed-frequency or default clock. This provides the entire CPS functionality to be bypassed, providing a fail-safe mechanism or a static clock during boot-up or testing. In combination, these components provide the processor's clock period to be adjusted on a cycle-by-cycle basis with a high degree of precision, thereby facilitating the advanced, deterministic power management strategies of the present disclosure.

For instance, this flip-flop structure can utilize programmable delays to determine the high-time and low-time of ChipClock. Programmable delays can, for example, be implemented as shift registers that are clocked by a high frequency clock that operates at, for example, eight times the nominal chip clock frequency, or other suitable multiplier. The duration of each phase of each clock cycle can be determined by “next state” values loaded into the high state and low state shift registers, respectively. Next state logic can be used to preload the shift registers with new period values on respective ChipClock edges. For a given resolution, the dynamic power of the shift registers can be cut in half by using rising and falling edges to implement half-cycle resolution. The precision of this operation may depend on the degree of symmetry in the duty cycle of the high frequency reference clock. The period of the high frequency clock and the number of shift register stages utilized for CPS can be determined by the nominal ChipClock period, the desired waveform granularity, and/or the maximum desired clock period for low power operating modes. For example, with a nominal 1 nS ChipClock period, 6.25% waveform granularity, and a maximum ChipClock period that is 16 times the nominal ChipClock period, the number of shift register stages can be determined as given below.

The duration of HFCPP can be the ChipClock period times the waveform granularity percentage, for example, 1 nS*6.25%=0.0625 nS (nanoseconds). The period of the HFC can be two times the duration of HFCPP or 2*0.0625 nS=0.125 nS. For instance, the HFC would be 8 GHz. The number of shift register stages can be determined as the maximum ChipClock period divided by the HFC period, or 16 nS/0.125 nS=128 DFF stages. In some implementations, a relatively smaller number of extra DFFs can be included to implement one HFCPP resolution. In some implementations, the shift register stages are allocated half to one period, the HighTime, and half to a second period, the LowTime.

In some implementations, CPS instructions can be orthogonal to other functional instructions. CPS instructions can dispatch as often as once per ChipClock. In the absence of any CPS instructions for a job, the ChipClock period may default to a default value at boot time. A CSR register write can be used to overwrite the HW default ChipClock period. Chip Reset can be used to set the ChipClock period to the default value. Cumulative clock periods can be aligned at data transfer times. The data transfer times can be considered invariant during instruction scheduling by the compiler. The compiler can track the real-time duration of the instructions executed on each chip in a multi-processor system. The real-time values can then be deterministically aligned at data transfer times. The compiler can be provided with flexibility to optimize clock durations on each individual processor.

Furthermore, in some implementations, system-level flexibility can be extended by using information from the Board Management Controller (BMC) to provide a multichip synchronization strategy that is adaptive to heterogeneous operating points that may change independently over time.

Software control of ChipClock periods can be achieved by configuring four exemplary CPS instruction parameter values: TargetPeriod, Slope, Steep, and Linear. In some implementations, all four parameters may be set in each instruction. The TargetPeriod can specify the number of HFCPP periods that are in each ChipClock period. The high time and low time may sometimes be balanced as much as possible by the hardware algorithms. A separate instruction may also be used to configure the Duration unit to operate with an asymmetric duty cycle for circuits such as memory arrays that involve an asymmetric duty cycle for optimized operation.

To control processor current flows, di/dt, it can sometimes be desirable to spread out instantaneous changes in the magnitude of current drawn by the processor. The Slope, Steep, and Linear parameters can specify the size of the incremental steps taken during each ChipClock period change while transitioning from the current value of ChipClock to the TargetPeriod. One example CPS instruction word format given uses up to 11 bits for the TargetPeriod field, which can also provide for future expansion.

In some implementations, newer CPS Instructions immediately preempt prior CPS instructions. This preemption can occur even if the ChipClock period is not yet equal to the TargetPeriod specified in the previous instruction (i.e., the ChipClock period is still changing). The Linear field can be used to linearize di/dt as the ChipClock period increases or decreases for small values of the ChipClock period. Without linearization, di/dt may be much larger for each change in ChipClock period for smaller ChipClock period durations. The pattern can resemble a concave curve that has the functional shape of 1/x. By reducing the di/dt for smaller ChipClock periods, the di/dt can be linearized.

The ability to set safe and reliable operating conditions can be desirable for electrical systems. In some implementations, the main operating V_{dd} voltage for the processor can be changed via the Board Management Controller (BMC), e.g., using a PCB microcontroller that interfaces with the voltage regulators through Serial Peripheral Interface (SPI) bus ports. Additionally and/or alternatively, the PCB clock generator frequency can be set to provide an appropriate reference clock frequency for the on-chip PLL. Changes to V_{dd} or the Reference Clock Frequency can be made between processing jobs. Changing the external Reference Clock Frequency while the processor is operating may, in some cases, result in invalid clock periods as the PLL tracks to lock-in on the new reference clock frequency.

In some implementations, software instructions can be used to change the V_{dd} operating voltage of the processor while a program is running. For example, a new CCU instruction can be defined that sends information out via one or more serial or parallel pins to be intercepted by the BMC microcontroller. The BMC microcontroller can, in response, reconfigure the V_{dd} voltage level, e.g., by changing the regulator using the SPI bus or other appropriate interface mechanisms depending on the PCB hardware. The microcontroller can then monitor the changing V_{dd} level to confirm that the voltage has stabilized at the new level. After confirming that the voltage has stabilized, the BMC can send an acknowledgement back to the processor. Clock period reductions or PLL clock frequency increases that utilize the new V_{dd} voltage can ensure that the new voltage has stabilized such as by monitoring the acknowledgement signal, or by waiting for some statutory time that is enforced as a constraint on the design of the BMC and voltage regulator latency.

One possible core instruction sequence is to issue a Sync command, then issue an external interrupt to the host via IO ICU, using the external interrupt to get the attention of the host. The interrupt can include a specific interrupt ID to inform the handler of the purpose of the interrupt. After the handler has provided the voltage change, the handler can set a CSR to notify the processor, e.g., by communicating an ACK signal back to the running program.

In some implementations, the CPS circuit 810 can be physically implemented in a Chip Control Unit (CCU) as illustrated in FIG. 8. Additionally and/or alternatively, the CPS ICU 808 can piggyback off of the nearest or otherwise most appropriate ICU block. For example, in one example LPU, the main vertical clock spine can be located at the median of the chip. This location provides that it can be desirable to locate the CPS ICU near the ICU blocks that serve VXM slices near the center of the chip.

FIG. 9 depicts a block diagram of a system 900 according to example aspects of the present disclosure. The system 900 includes a multiphase voltage regulator 902 that provides improved responsiveness in applications that are time sensitive in voltage shifting. The voltage regulator 902 can provide a plurality of voltage phases 904. Each phase 904 can include a respective power stage 905 and/or phase control circuitry 907. The power stage 905 and phase control circuitry 907 can provide for each phase 904 to be independently operable. A subset of the total number of phases 904 can output different pre-stabilized voltages. A switch 906 can be coupled to the plurality of voltage phases 904 such that the phases 904 can be selectively toggled. By providing different pre-stabilized voltages at a subset of the voltage phases 904, a controller (e.g., a power management integrated circuit controller or PMIC controller 910) can selectively control which phases 904 are applied for a particular compute cycle.

The phases 904 of the VRN 902 can be coupled to a common power delivery network 912 on the deterministic processor. By providing each phase at a common power delivery network 912, the VRN 902 can provide even power distribution and/or mitigate effects of isolation between voltage domains. The PMIC controller 910 can act as a central control unit for processors utilizing the VRN 902. For instance, the PMIC controller 910 can orchestrate activation and/or deactivation of certain phases 904, such as phases 904 that provide the same voltage, to provide rapid voltage transitions. The PMIC controller 910 can communicate with the VRN 902 to activate or deactivate the phases as needed (e.g., via the switch 906). As one example, based on the voltage signal determined from the predictive power analysis of schedule 914, the PMIC controller 910 generates and sends a control signal to the switch 906. The switch 906, in response, selects one or more of the phases 904 and couples their output directly to the common power delivery network 912 of the processor. This action delivers the desired voltage to the entire processor core or specific voltage domains within it.

The PMIC controller 910 can, in some implementations, provide for determining the clock periods and/or voltage signals to be generated at each compute cycle. For instance, the PMIC controller 910 can receive a deterministic schedule 914 from a compiler of the processor and determine the control signals to be applied to the switch 906 at each compute cycle. The PMIC controller 910 can provide smooth transitions to maintain system stability and/or prevent electrical glitches.

Furthermore, the VRN 902 according to the present disclosure can, in some implementations, include (e.g., only) linear components such as resistors, diodes, or transistors (with respect to time-varying voltage signals). For instance, the components may lack reactivity based on a frequency of changing voltage, as contrasted with non-linear components, such as inductors or capacitors, where energy characteristics of the components are dependent on a frequency of the changing voltage. Furthermore, these components may be operated in a range where the components behave linearly, such as, for example, where relationships between voltage and current through the component follow a generally linear form over the range of voltage and/or current values experienced by the components. As an example, resistors may be operated in a region where voltage drop across the resistor is proportional to the current through the resistor. As another example, diodes may operate in a quasi-linear range (e.g., having a voltage greater than the breakdown voltage of the diode and/or having forward voltage as opposed to a reverse voltage) where the diode passes substantially all current through it above a certain activation voltage. The VRN 902 can further provide for removing inductors, capacitors, and other components that behave nonlinearly with respect to time-varying voltage signals, or circuitry including such components (e.g., filters). The voltage switching mechanisms of the VRN 902 can thus provide for rapidly changing active phases, minimizing transition time, and avoiding power disruptions.

Thus, the system 900 provides the hardware architecture for achieving the rapid, fine-grained voltage switching supporting aggressive Dynamic Voltage and Frequency Scaling (DVFS) and Cycle-by-Cycle Period Scaling (CPS) in a deterministic processor, such as the processor 106 of FIG. 1 or LPU 401 of FIG. 4. In accordance with the present disclosure, the PMIC controller 910 can be communicatively coupled to a compiler (such as compiler 108 of FIG. 1) or a memory location where the compiler's output is stored. The PMIC controller 910 may therefore obtain a deterministic schedule 914, which contains a precise, cycle-by-cycle plan of operations to be executed by the various functional slices (e.g., MXM 409, VXM 410, MEM 407 of FIG. 4) of the processor. This schedule provides the PMIC controller 910 with predictive, “look-ahead” knowledge of the processor's future power demands. For example, the schedule may indicate a series of low-power memory access operations followed by a computationally intensive matrix multiplication, which presents a large and sudden increase in load current.

For instance, in some examples, each phase 904 can include its own power stage and control circuitry providing for independent operation. At least a subset of the plurality of phases 904 are configured to output different, discrete, and pre-stabilized voltage levels. For example, a first group of phases may be set to output 0.8V for low-power operations, a second group may be set to output 0.9V for nominal operations, and a third group may be set to output 1.0V for high-performance “turbo” operations. The number of phases assigned to each voltage level can be engineered to meet the anticipated current draw at that voltage. The phases 904 may be coupled to a common, high-speed switch 906. In some implementations, the VRN 902 and its phases 904 are constructed primarily using linear components (e.g., resistors, diodes, transistors operating in their linear region) and avoid or minimize the use of large inductive or capacitive elements in the final output stage to maximize switching speed.

The operation of system 900 directly addresses the challenges illustrated in FIGS. 7A-7B. For instance, by analyzing the deterministic schedule 914, the PMIC controller 910 can anticipate a large power-up event, such as the one causing the severe V_{dd} droop 745. Instead of reactively trying to supply the current, the PMIC 910 proactively controls the VRN 902. Just before the high-power operation begins, it can instruct the switch 906 to select a higher voltage phase. Because this is a selection of a pre-stabilized voltage source rather than ramping up a single source, the voltage transition is near-instantaneous. This rapid voltage availability provides the CPS system 800 of FIG. 8 to simultaneously switch to a higher clock frequency that utilizes the higher voltage. The result is a controlled power ramp-up, as shown in trace 752 of FIG. 7C, which maintains a stable V_{dd} and provides the processor to transition from low to high performance without risking timing errors or system instability. This architecture effectively bypasses the slow response time of traditional VRNs that rely on charging and discharging large inductors, thereby enabling the aggressive, cycle-by-cycle power optimization demanded by deterministic computing environments.

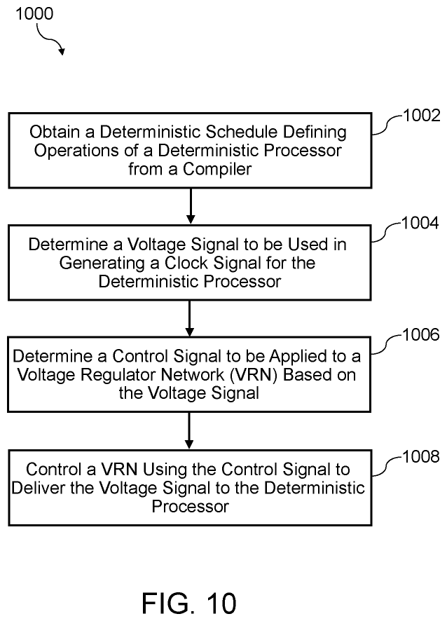

FIG. 10 depicts a flowchart diagram of an example method 1000 according to example aspects of the present disclosure. Although FIG. 10 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

This computer-implemented method can be performed by a power management system, such as a Power Management Integrated Circuit (PMIC) controller, in a computing system that includes a deterministic processor. The steps outlined in method 1000 provide proactive, fine-grained power management by leveraging the predictive nature of a deterministic schedule to control a specialized multiphase Voltage regulator network (VRN).

The method 1000 can include, at 1002, obtaining a deterministic schedule defining operations of a deterministic processor from a compiler. This schedule may be a detailed, cycle-accurate plan that specifies which instructions will be executed by which functional units of the processor at specific future times. For instance, the PMIC controller can access this schedule from a shared memory location to gain predictive insight into upcoming workloads. This “look-ahead” capability provides for the power management system to anticipate shifts in power demand, such as a transition from low-power memory operations to a high-power matrix multiplication, well before they occur.

The method 1000 can further include, at 1004, determining a voltage signal to be used in generating a clock signal for the deterministic processor. Based on the foreknowledge of the upcoming operations from the deterministic schedule, the system can determine the optimal supply voltage for the next compute cycle or block of cycles. This determination can balance performance with approaches for minimizing power consumption. For example, if the schedule indicates a period of low computational intensity, a lower voltage signal can be selected to save power.

In some implementations, determining the voltage signal to be used in generating the clock signal can include determining, based on the deterministic schedule, a clock period of the clock signal respective to a compute cycle of the deterministic schedule. This step can, for example, correspond to the frequency scaling aspect of Dynamic Voltage and Frequency Scaling (DVFS). The PMIC controller can analyze the timing requirements of the scheduled operations to select an appropriate clock period. This process, also known as cycle-by-cycle period scaling (CPS), provides the processor to speed up for demanding periods and slow down during less demanding periods, providing granular control over performance, while respecting power utilization constraints.

In some implementations, the method can then involve determining, based on the selected clock period, a voltage to be used in generating the clock signal having that clock period for the compute cycle. In many processor designs, higher clock frequencies are generated by supplying higher voltages to provide stable operation and/or to meet timing constraints. The PMIC controller can use this relationship, which may be stored in a lookup table or calculated via a formula, to map the chosen clock period to a specific voltage level. Thus, a processor may be supplied with voltage that is sufficient for the intended operating frequency.

The method 1000 can further include, at 1006, determining a control signal to be applied to a voltage regulator network (VRN) based on the voltage signal. This step involves translating a voltage specification (e.g., “0.95V”) into a concrete, hardware-level command for the VRN. For a multiphase VRN with multiple pre-set voltage outputs, this control signal can be a digital code that specifies which of the available phases to activate. The PMIC controller can be responsible for generating this specific control signal to orchestrate the VRN's behavior.

The method 1000 can conclude at 1008 by controlling the VRN using the control signal to deliver the voltage signal to the deterministic processor. The PMIC controller transmits the determined control signal to the VRN's switching circuitry, triggering the physical change in the voltage supply. Because this control is proactive and based on the deterministic schedule, the voltage supply can be adjusted just before the workload changes. This preemptive action effectively prepares the processor for the new power demand, mitigating or eliminating the severe voltage droop associated with sudden load increases.

In some implementations, controlling the VRN using the control signal can involve operating a switch to select one or more of the plurality of phases to deliver the voltage signal. This high-speed switch can be the central mechanism for rapid voltage transitions. Instead of waiting for a single power stage to ramp its voltage up or down, the switch can near-instantaneously connect the output of a different, already-stabilized voltage phase to the processor. This selection and connection process can occur in nanoseconds, enabling the near-instantaneous voltage changes beneficial for cycle-by-cycle power management.

In some implementations, delivering the voltage signal to the deterministic processor can include delivering the voltage signal to a common power delivery network of the deterministic processor. This network is the on-chip grid of conductive layers that distributes power to all the transistors and functional units across the die. By having all VRN phases connect to this common network via the switch, the system can provide that the selected voltage is uniformly and stably supplied across the entire processor core. This approach can help avoid potential issues of voltage islands or localized power starvation.

In some implementations, the plurality of phases of the VRN that are being controlled can respectively include a power stage and control circuitry. This architecture provides each phase, or group of phases, to function as an independent, stable voltage source. The power stage is designed to handle the current delivery, while the local control circuitry for each phase is responsible for maintaining its specific output voltage with high precision. This makes each phase “ready to serve” its designated voltage level the moment it is selected by the main switch.

In some implementations, the plurality of phases can respectively output different pre-stabilized voltages. This can be useful for providing the rapid, discrete voltage steps of the system. For example, a VRN can be designed with phases dedicated to outputting 0.8V, 0.9V, and 1.0V. This provides the PMIC controller to choose the most appropriate power-performance state for the upcoming workload and switch to it almost instantly, rather than being limited by the continuous but slow ramping of a traditional VRN.

In some implementations, the VRN can include components that behave linearly with respect to changes in voltage over time. This design choice can provide for prioritizing speed by avoiding components with slow transient responses, such as large inductors and capacitors, at the final output stage. By using fast-switching linear components like resistors and transistors, the system ensures that the voltage at the power delivery network can settle extremely quickly after a switch between phases. This characteristic is useful for stable processor operation when the voltage and clock frequency are adjusted on a cycle-by-cycle basis.

In an aspect, the present disclosure provides an example computing system including a deterministic processor; a compiler configured to translate a program into a deterministic schedule including a plurality of operations defined for implementation on the deterministic processor; a voltage regulator network (VRN) including a plurality of phases; and a power management integrated circuit (PMIC) controller configured to obtain the deterministic schedule from the compiler, determine a voltage signal to be used in generating a clock signal for the deterministic processor, determine a control signal to be applied to the VRN based on the voltage signal, and control the VRN using the control signal to deliver the voltage signal to the deterministic processor.

In some implementations, the plurality of phases respectively include a power stage and control circuitry.

In some implementations, controlling the VRN using the control signal includes operating a switch to select one or more of the plurality of phases to deliver the voltage signal.

In some implementations, delivering the voltage signal to the deterministic processor includes delivering the voltage signal to a power delivery network of the deterministic processor.

In some implementations, determining the voltage signal to be used in generating the clock signal for the deterministic processor includes determining, based on the deterministic schedule, a clock period of the clock signal respective to a compute cycle of the deterministic schedule, and determining, based on the clock period, a voltage to be used in generating the clock signal having the clock period for the compute cycle.

In some implementations, the plurality of phases respectively output different pre-stabilized voltages.

In some implementations, the VRN includes components that behave linearly with respect to changes in voltage over time.

In an aspect, the present disclosure provides an example computer-implemented method including obtaining a deterministic schedule defining operations of a deterministic processor from a compiler; determining a voltage signal to be used in generating a clock signal for the deterministic processor; determining a control signal to be applied to a voltage regulator network (VRN) based on the voltage signal; and controlling the VRN using the control signal to deliver the voltage signal to the deterministic processor.

In some implementations, the plurality of phases respectively include a power stage and control circuitry.

In some implementations, controlling the VRN using the control signal includes operating a switch to select one or more of the plurality of phases to deliver the voltage signal.

In some implementations, delivering the voltage signal to the deterministic processor includes delivering the voltage signal to a power delivery network of the deterministic processor.

In some implementations, determining the voltage signal to be used in generating the clock signal for the deterministic processor includes determining, based on the deterministic schedule, a clock period of the clock signal respective to a compute cycle of the deterministic schedule, and determining, based on the clock period, a voltage to be used in generating the clock signal having the clock period for the compute cycle.

In some implementations, the plurality of phases respectively output different pre-stabilized voltages.

In some implementations, the VRN includes components that behave linearly with respect to changes in voltage over time.

In an aspect, the present disclosure provides an example power management integrated circuit (PMIC) controller configured to obtain a deterministic schedule defining operations of a deterministic processor from a compiler; determine a voltage signal to be used in generating a clock signal for the deterministic processor; determine a control signal to be applied to a VRN based on the voltage signal; and control the VRN using the control signal to deliver the voltage signal to the deterministic processor.

In some implementations, the plurality of phases respectively include a power stage and control circuitry.

In some implementations, controlling the VRN using the control signal includes operating a switch to select one or more of the plurality of phases to deliver the voltage signal.

In some implementations, delivering the voltage signal to the deterministic processor includes delivering the voltage signal to a power delivery network of the deterministic processor.

In some implementations, determining the voltage signal to be used in generating the clock signal for the deterministic processor includes determining, based on the deterministic schedule, a clock period of the clock signal respective to a compute cycle of the deterministic schedule, and determining, based on the clock period, a voltage to be used in generating the clock signal having the clock period for the compute cycle.

In some implementations, the plurality of phases respectively output different pre-stabilized voltages.

Additionally, the present disclosure provides a method according to any of the aspects described herein.

Additionally, the present disclosure provides an apparatus according to any of the aspects described herein.

Additionally, the present disclosure provides one or more non-transitory, computer-readable media storing instructions that, when implemented, cause one or more processors to perform operations including any of the aspects described herein.

While the present subject matter has been described in detail with respect to specific example implementations thereof, it will be appreciated that those skilled in the art, upon attaining an understanding of the foregoing can readily produce alterations to, variations of, and equivalents to such implementations. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computing system, comprising:
a deterministic processor;
a compiler configured to translate a program into a deterministic schedule comprising a plurality of operations defined for implementation on the deterministic processor;
a voltage regulator network (VRN) comprising a plurality of phases; and
a power management integrated circuit (PMIC) controller configured to:
obtain the deterministic schedule from the compiler;
determine a voltage signal to be used in generating a clock signal for the deterministic processor;
determine a control signal to be applied to the VRN based on the voltage signal; and
control the VRN using the control signal to deliver the voltage signal to the deterministic processor.

2. The computing system of claim 1, wherein the plurality of phases respectively comprise a power stage and control circuitry.

3. The computing system of claim 1, wherein controlling the VRN using the control signal comprises operating a switch to select one or more of the plurality of phases to deliver the voltage signal.

4. The computing system of claim 1, wherein delivering the voltage signal to the deterministic processor comprises delivering the voltage signal to a power delivery network of the deterministic processor.

5. The computing system of claim 1, wherein determining the voltage signal to be used in generating the clock signal for the deterministic processor comprises:
determining, based on the deterministic schedule, a clock period of the clock signal respective to a compute cycle of the deterministic schedule; and
determining, based on the clock period, a voltage to be used in generating the clock signal having the clock period for the compute cycle.

6. The computing system of claim 1, wherein the plurality of phases respectively output different pre-stabilized voltages.

7. The computing system of claim 1, wherein the VRN comprises components that behave linearly with respect to changes in voltage over time.

8. A computer-implemented method, comprising:
obtaining a deterministic schedule defining operations of a deterministic processor from a compiler;
determining a voltage signal to be used in generating a clock signal for the deterministic processor;
determining a control signal to be applied to a voltage regulator network (VRN), the VRN comprising a plurality of phases, based on the voltage signal; and
controlling the VRN using the control signal to deliver the voltage signal to the deterministic processor.

9. The computer-implemented method of claim 8, wherein the plurality of phases respectively comprise a power stage and control circuitry.

10. The computer-implemented method of claim 8, wherein controlling the VRN using the control signal comprises operating a switch to select one or more of the plurality of phases to deliver the voltage signal.

11. The computer-implemented method of claim 8, wherein delivering the voltage signal to the deterministic processor comprises delivering the voltage signal to a power delivery network of the deterministic processor.

12. The computer-implemented method of claim 8, wherein determining the voltage signal to be used in generating the clock signal for the deterministic processor comprises:
determining, based on the deterministic schedule, a clock period of the clock signal respective to a compute cycle of the deterministic schedule; and
determining, based on the clock period, a voltage to be used in generating the clock signal having the clock period for the compute cycle.

13. The computer-implemented method of claim 8, wherein the plurality of phases respectively output different pre-stabilized voltages.

14. The computer-implemented method of claim 8, wherein the VRN comprises components that behave linearly with respect to changes in voltage over time.

15. A power management integrated circuit (PMIC) controller configured to:
obtain a deterministic schedule defining operations of a deterministic processor from a compiler;
determine a voltage signal to be used in generating a clock signal for the deterministic processor;
determine a control signal to be applied to a VRN, the VRN comprising a plurality of phases, based on the voltage signal; and
control the VRN using the control signal to deliver the voltage signal to the deterministic processor.

16. The PMIC controller of claim 15, wherein the plurality of phases respectively comprise a power stage and control circuitry.

17. The PMIC controller of claim 15, wherein controlling the VRN using the control signal comprises operating a switch to select one or more of the plurality of phases to deliver the voltage signal.

18. The PMIC controller of claim 15, wherein delivering the voltage signal to the deterministic processor comprises delivering the voltage signal to a power delivery network of the deterministic processor.

19. The PMIC controller of claim 15, wherein determining the voltage signal to be used in generating the clock signal for the deterministic processor comprises:
determining, based on the deterministic schedule, a clock period of the clock signal respective to a compute cycle of the deterministic schedule; and
determining, based on the clock period, a voltage to be used in generating the clock signal having the clock period for the compute cycle.

20. The PMIC controller of claim 15, wherein the plurality of phases respectively output different pre-stabilized voltages.
